(19) United States
(12) Patent Application Publication
(10) Pub. No.: US 2022/0243075 A1
(43) Pub. Date: Aug. 4, 2022

(54) COMPOSITION, FILM, KIT, COATED SUBSTRATE, AND RELATED METHODS THEREOF

(71) Applicant: Agency for Science, Technology and Research, Singapore (SG)

(72) Inventors: Ritwik Panigrahi, Singapore (SG); Alexander Maria Van Herk, Singapore (SG); Praveen Thoniyot, Singapore (SG)

(21) Appl. No.: 17/599,048

(22) PCT Filed: Mar. 27, 2020
(86) PCT No.: PCT/SG2020/050184

§ 371 Date: Sep. 28, 2021

(30) Foreign Application Priority Data
Mar. 28, 2019 (SG) 10201902802W

(51) Int. Cl. C09D 7/61; C09D 5/02; C09D 7/80; C09D 133/10; C08J 5/18; C08J 3/24

(52) U.S. Cl. CPC C09D 7/61; C09D 5/028; C09D 7/80; C09D 7/67; C08J 5/18; C08J 3/24; C09D 133/10

(57) ABSTRACT

There is provided a composition comprising: (i) a polymer; (ii) inorganic particles; and (iii) aqueous medium, wherein the inorganic particles are adapted to interact with the polymer to cause an increase in glass transition temperature (Tg) during film formation of the composition. Also provided are a film, a method of preparing said film, a kit and a coated substrate.

### CROSS REFERENCE TO RELATED APPLICATIONS

This patent application is the national stage of International Patent Application No. PCT/SG2020/050184, filed on Mar. 27, 2020, which claims the benefit and priority of Singaporean Patent Application No. 10201902802W, filed on Mar. 28, 2019, the disclosures being incorporated by reference herein in their entirety as part of the present application.

### TECHNICAL FIELD

The present disclosure relates broadly to a composition, a film, a kit and a coated substrate. The present disclosure also relates to a method of preparing said film.

### BACKGROUND

Small organic compounds (SOCs) are compounds with high vapor pressures that volatize easily into the atmosphere. These compounds may have adverse effects on the environment and human health. Exposure to SOCs have been linked to acute toxicity in human such as changes in skin pigmentation as well as chronic toxicity such as tumour growth and skin cancer. One major source of man-made SOCs emissions are coating formulations.

Coating formulations used worldwide contain SOCs or volatile organic compounds (VOCs) in the form of plasticizers to aid in film formation processes. Due to environmental and health concerns, coating formulations such as waterborne paints have steadily replaced solvent-based paints over the years. The SOC content of waterborne paints is significantly lower than conventional solvent-based paints. However, there is still between about 5-15% volatile plasticizers being used in currently available waterborne paints.

Studies have been performed to reduce the percentage of SOCs or VOCs in coating formulations but none has been successful. For example, paint companies have focused their research on modification of binder in order to reduce the percentage of plasticizer used but such an approach has not been successful. Further, such approach of modifying the polymer binder such as latex binder has several disadvantages as it is not cost effective and is often application specific. There have been discussions on the reduction of plasticizer using some approaches but to date, there is no relevant report on methods to completely avoid the use of plasticizer.

Indeed, the search for a suitable method to effectively reduce or completely eliminate SOCs from coating formulations remains futile. More than 10% SOCs are still present in current coating formulations. It has been reported that in a year, an average of 300 kilotonnes of SOCs are released into the environment by exterior coating industry alone in spite of the usage of reduced VOC formulations. This may be due to the replacement of VOC with high boiling SOCs to bypass the regulatory definitions of VOCs. Consequently, these SOCs will eventually still end up in the environment.

While research and development are ongoing with the aim of reducing VOC usages to obtain what is commonly known as low VOC paint, commercially available zero VOC water based polymer (e.g. latex) paint is still lacking.

In view of the above, there is a need to address or at least ameliorate the above-mentioned problems. In particular, there is a need for a composition, a film, a kit and a coated substrate that address or at least ameliorate the above-mentioned problems.

### SUMMARY

In one aspect, there is provided a composition comprising: (i) a polymer; (ii) inorganic particles; and (iii) aqueous medium, wherein the inorganic particles are adapted to interact with the polymer to cause an increase in glass transition temperature (Tg) during film formation of the composition.

In one embodiment, the increase in Tg during film formation of the composition is due to a nanoconfinement effect.

In one embodiment, the increase in Tg from Tg of the polymer to Tg of the film comprises a temperature increase in an amount of at least 10° C.

In one embodiment, the interactions involving the inorganic particles and the polymer in the aqueous medium comprise non-covalent interactions.

In one embodiment, the composition is substantially devoid of a plasticizer.

In one embodiment, the composition is substantially devoid of small organic compounds (SOC) and/or volatile organic compounds (VOC).

In one embodiment, the inorganic particles comprise inorganic nanoparticles having an average size that is no more than 200 nm.

In one embodiment, the inorganic nanoparticles are selected from the group consisting of silicon dioxide, titanium dioxide, clay, nanocrystalline cellulose and lignin powders.

In one embodiment, the polymer is a polymer comprising one or more types of monomers selected from styrene; acrylic acid; methacrylic acid; maleic acid; itaconic acid; acrylonitrile; methacrylonitrile; butadiene; vinylidene chloride; vinyl acetate; and derivatives thereof.

In one embodiment, the acrylic acid derivative thereof is selected from methyl acrylate, ethyl acrylate, butyl acrylate, 2-ethylhexyl acrylate (2EHA) and N,N,dimethylacrylamide (NNDMA); and the methacrylic acid derivative thereof is selected from methyl methacrylate (MMA) and (hydroxyethyl) methacrylate (HEMA).

In one embodiment, the aqueous medium is in an amount of from 30 wt % to 60 wt % of the composition.

In one embodiment, the inorganic particles are in the amount of from 0.05 wt % to 5.0 wt % of the composition.

In one embodiment, the polymer is in an amount of from 10 wt % to 40 wt % of the composition.

In one embodiment, the composition is a paint composition and further comprises one or more of the following: pigment, filler, wetting agent, thickening agent, base, anti-foaming agent and dispersing agent.

In one aspect, there is provided a film comprising: a polymer that is in non-covalent interaction with inorganic particles, wherein the inorganic particles are adapted to interact with the polymer to cause an increase in Tg during formation of the film from the composition disclosed herein.

In one embodiment, the film has one or more of the following properties: odourless, non-tacky, non-sticky, excellent resistance to scrub, excellent resistance to abrasion, excellent resistance to washing, low or zero wetting, low water vapour transmission rate under dry conditions, chemically and/or physically stable, excellent resistance towards natural exposure/weathering.

In one embodiment, the film has a glass transition temperature in the range of from 15.0° C. to 40.0° C.

In one aspect, there is provided a method of preparing a film, the method comprising mixing inorganic particles, aqueous medium and optionally one or more of pigment, filler, wetting agent, thickening agent, base, anti-foaming agent, and dispersing agent, to form a mill base; mixing said mill base with a polymer to form a composition; applying the composition on/over a substrate; and optionally curing the composition to form a film on/over the substrate, wherein the inorganic particles are adapted to interact with the polymer to cause an increase in glass transition temperature (Tg) during film formation of the composition. The polymer may be in the form of a polymer solution and/or a dispersion in water. For example, the polymer may be in the form of polyvinyl alcohol and/or latex.

In one embodiment, the step of mixing to form a mill base comprises stirring the mixture until the particle size is less than 50 μm as determined by a Hegman gauge.

In one aspect, there is provided a kit comprising: (i) a polymer; and (ii) a mill base separately stored from the polymer and adapted to be mixed with the polymer, the mill base comprising inorganic particles, an aqueous medium and optionally one or more of pigment, filler, wetting agent, surfactant, thickener, thickening agent, base, defoamer, anti-foaming agent, dispersant, and dispersing agent, wherein the inorganic particles are adapted to interact with the polymer to cause an increase/jump in glass transition temperature (Tg) during formation of the film from a composition obtained by mixing said mill base with said polymer.

In one aspect, there is provided a coated substrate comprising: a layer of the composition disclosed herein applied on/over a surface of the substrate.

### DEFINITIONS

The term “latex” as used herein is to be interpreted broadly to refer to any dispersion/emulsion of one or more polymer(s) and/or copolymer(s).

The term “micro” as used herein is to be interpreted broadly to include dimensions from about 1 micron to about 1000 microns.

The term “nano” as used herein is to be interpreted broadly to include dimensions less than about 1000 nm.

The term “particle” as used herein broadly refers to a discrete entity or a discrete body. The particle described herein can include an organic, an inorganic, a hybrid or a biological particle etc. The particle used described herein may also be a macro-particle that is formed by an aggregate of a plurality of sub-particles or a fragment of a small object. The particle of the present disclosure may be spherical, substantially spherical, or non-spherical, such as irregularly shaped particles or ellipsoidally shaped particles. The term “size” when used to refer to the particle broadly refers to the largest dimension of the particle. For example, when the particle is substantially spherical, the term “size” can refer to the diameter of the particle; or when the particle is substantially non-spherical, the term “size” can refer to the largest length of the particle.

The terms “coupled” or “connected” as used in this description are intended to cover both directly connected or connected through one or more intermediate means, unless otherwise stated.

The term “associated with”, used herein when referring to two elements refers to a broad relationship between the two elements. The relationship includes, but is not limited to a physical, a chemical or a biological relationship. For example, when element A is associated with element B, elements A and B may be directly or indirectly attached to each other or element A may contain element B or vice versa.

The term “adjacent” used herein when referring to two elements refers to one element being in close proximity to another element and may be but is not limited to the elements contacting each other or may further include the elements being separated by one or more further elements disposed there between.

The term “and/or”, e.g., “X and/or Y” is understood to mean either “X and Y” or “X or Y” and should be taken to provide explicit support for both meanings or for either meaning.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For example, when “comprising” is used, reference to a “one” feature is also intended to be a reference to “at least one” of that feature. Terms such as “consisting”, “consist”, and the like, may in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

Additionally, when describing some embodiments, the disclosure may have disclosed a method and/or process as a particular sequence of steps. However, unless otherwise required, it will be appreciated that the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Furthermore, it will be appreciated that while the present disclosure provides embodiments having one or more of the features/characteristics discussed herein, one or more of these features/characteristics may also be disclaimed in other alternative embodiments and the present disclosure provides support for such disclaimers and these associated alternative embodiments.

### DESCRIPTION OF EMBODIMENTS

Exemplary, non-limiting embodiments of a composition, a film, a kit, a coated substrate and related methods are disclosed hereinafter.

There is provided a composition comprising a polymer, inorganic particles and aqueous medium. In various embodiments, the composition is a water-based composition, water-based formulation or water-based system. In various embodiments, the composition is suitable for use as a coating formulation. In various embodiments, the polymer is substantially insoluble in water or an aqueous medium or water-based system. In various embodiments, the polymer is latex. The coating formulation may be a water-based latex paint formulation. In various embodiments, the coating formulation may be used as a paint coating or a paint formulation.

In various embodiments, the composition is substantially/completely devoid of or substantially/completely free of plasticizer (such as a plant dispersant) and/or film forming agent and/or coalescing agent. Advantageously, in various embodiments, preparation/formation of the composition disclosed herein does not require use of any plasticizer for promoting coalescence. Such advantageous effects are not easily achievable by currently known methods. It will be appreciated that such known methods typically require the addition of plasticizers to reduce Tg in order to promote coalescing.

In various embodiments, the composition is substantially/completely devoid of or substantially/completely free of small organic compounds e.g. those having an aliphatic chain of from about 1 to about 20 carbon atoms (SOC) and/or volatile organic compounds (VOC). For example, in various embodiments, the composition does not contain any non-polymeric organic component.

Advantageously, various embodiments of the composition disclosed herein overcome or at least ameliorate one or more of the inherent issues of plasticizers, SOCs or VOCs in conventional coating formulations as described above.

In various embodiments, the composition makes use of a Tg jump effect in the water-based system from the interaction between polymer binders e.g. latex polymer binders and nanoadditives, to produce a coating that is substantially free from small organic compounds and/or plasticizers. In various embodiments, the inorganic particles are configured/adapted to or capable of interacting/reacting with the polymer to cause an increase/jump in glass transition temperature (Tg) during film formation of the composition. Advantageously, a synergistic interaction between the inorganic particles and the polymer in the aqueous medium is believed to favourably promote the formation of a film by creating a Tg jump from Tg of the polymer (e.g. latex) to Tg of the film.

Without being bound by theory, it is believed that the interaction between the inorganic particles and the polymer (e.g. latex) in the aqueous medium to cause an increase/jump in Tg occurs through a nanoconfinement effect. Without being bound by theory, it is also believed that the incorporation of inorganic particles into the polymer (e.g. latex) restricts the movement of the polymer (e.g. latex), thus inducing/giving rise to a nanoconfinement effect. Nanoconfinement effect may be observed upon deconvolution of the infra-red spectroscopic data of the solid film formed after the composition containing polymer (e.g. latex) and nanoparticles are dried. Nanoconfinement effect could also be evidenced from the comparison of observed Tg of the said film with the Tg of the polymer film without any nanoparticles in it. In various embodiments, nanoconfinement effect refers to the change in physical and/or chemical properties of a polymer or molecule when it is confined in the nanosized regime of less than about 1,000 nm, less than about 500 nm, less than about 250 nm or from about 10-100 nm regime.

Therefore, in various embodiments, the composition is a water-based system that applies nanoconfinement effect of polymer (e.g. latex) chains as a controlling factor in order to avoid the use of a plasticizer.

In various embodiments, the amount of plasticizer and/or film forming agent and/or coalescing agent in the composition is substantially less than about 5 wt %, less than about 1 wt % of the composition, less than about 0.5 wt %, less than about 0.1 wt %, less than about 0.05 wt % or less than about 0.01 wt % of the composition.

In various embodiments, the increase/jump in Tg (from Tg of the polymer (e.g. latex) to Tg of the film) comprises a temperature increase/jump of at least about 1° C., at least about 2° C., at least about 3° C., at least about 4° C., at least about 5° C., at least about 6° C., at least about 7°, at least about 8° C., at least about 9° C., at least about 10° C., at least about 11° C., at least about 12° C., at least about 13° C., at least about 14° C., at least about 15° C., at least about 16° C., at least about 17°, at least about 18° C., at least about 19° C., at least about 20° C., at least about 21° C., at least about 22° C., at least about 23° C., at least about 24° C., at least about 25° C. or higher. For example, the increase/jump in Tg may refer to a jump from Tg of the polymer particles (e.g. latex) to the Tg of the polymer in the paint/film. In various embodiments, in systems where stronger interactive groups are present in either the polymer or nanoparticle, the Tg increase/jump may go higher than 25° C.

In various embodiments, the interactions involving the inorganic particles and the polymer (e.g. latex) in the aqueous medium comprise non-covalent/non-permanent interactions. In various embodiments, the non-covalent/non-permanent interactions comprises interfacial physical interactions between inorganic particles and polymer (e.g. latex) and/or hydrogen bonding interactions between inorganic particles, polymer (e.g. latex) and the aqueous medium. Hydrogen bonding interactions may occur between H₂O molecules in the aqueous medium. Hydrogen interactions may also occur between inorganic particles and polymer chains (e.g. latex). In various embodiments, the non-covalent interactions comprise an immensely large number of interactions. It will be appreciated by a person skilled in the art that due to the large number of non-covalent interactions, such interactions are capable of/sufficient to impart desired properties such as high Tg of the film formed, even though non-covalent interactions may be considered weak as compared to other interactions such as covalent interactions.

In various embodiments, the inorganic particles are present in lieu of plasticizers that temporarily lower the Tg of the polymer (e.g. latex) to promote coalescing, which then evaporate to cause an increase in the Tg (for e.g. back to its original Tg) when a film is formed from the composition. In various embodiments, such plasticizers are organic plasticizers.

In various embodiments, the inorganic particles are a substitute/replacement/alternative for a plasticizer, i.e. the inorganic particles are plasticizer substitute/replacement/alternative. In various embodiments, inorganic particles (for e.g. inorganic nanoparticles) are used in an innovative manner such that no plasticizer is necessary. For example, an intelligent addition of inorganic nanoparticles may enable the complete removal of plasticizer from a formulation although the quantity of the plasticizer removed may not necessary be the same as the quantity of the inorganic nanoparticles added to the formulation.

In some embodiments, the inorganic particles may also be referred to as additives. The inorganic particle may be any hard particle that is able to effectively interact with the polymer (e.g. latex) to generate the nanoconfinement effect (such as silica, titanic, clay, nanocrystalline cellulose, natural materials like lignin powders etc.). The size of the particles may be in the nanoscale range, such as sub 100 nm or even sub 10 nm. In some embodiments, it may be desirable to have a lot of groups present on the surface of the particles that can interact with polymer end groups to enhance the nanoconfinement effect. In various embodiments, inorganic nanoparticle which is capable of creating noncovalent interaction with the polymer binder leading to create Tg jump, may be useful in the presently disclosed strategy. In various embodiments therefore, prior to selecting any unknown inorganic nanoparticle, a thorough testing may be employed to check for functional efficiency.

In various embodiments, the inorganic particles are inorganic nanoparticles/plasticizer substitute selected from silica/silicon dioxide/SiO₂(such as fumed or dispersed silica), titania/titanium oxide/titanium dioxide/TiO₂, clay, nanocrystalline cellulose, natural materials (such as lignin powders) and the like. In various embodiments, the inorganic particles used to induce nanoconfinement effect are commercially available as aqueous dispersions.

In various embodiments, the inorganic particles comprise inorganic nanoparticles that are present in the range of from about 0.05 wt % to about 5.0 wt %, from about 0.1 wt % to about 4.5 wt %, from about 0.2 wt % to about 4.0 wt %, from about 0.3 wt % to about 3.5 wt %, from about 0.4 wt % to about 3.0 wt %, from about 0.5 wt % to about 2.5 wt %, from about 1.0 wt % to about 2.0 wt %, or about 1.5 wt % of the composition.

In various embodiments, the inorganic nanoparticles have an average size that is no more than about 200 nm, no more than about 100 nm, no more than about 90 nm, no more than about 80 nm, no more than about 70 nm, no more than about 60 nm, no more than about 50 nm, no more than about 40 nm, no more than about 30 nm, no more than about 20 nm, no more than about 10 nm, no more than about 5 nm, no more than about 4 nm, no more than about 3 nm, no more than about 2 nm or no more than about 1 nm. The inorganic particles may be detected through analysis of the composition using high resolution transmission electron microscopy.

In various embodiments, the aqueous medium comprises water and contains no other intentionally added low volatile compounds or solvents. In various embodiments, the aqueous medium is water.

In various embodiments, the amount of aqueous medium present in the composition is in the range of from about 30 wt % to about 60 wt %, from about 32 wt % to about 58 wt %, from about 34 wt % to about 56 wt %, from about 36 wt % to about 54 wt %, from about 38 wt % to about 52 wt %, from about 40 wt % to about 50 wt %, from about 42 wt % to about 48 wt %, from about 44 wt % to about 46 wt % or about 45 wt % of the composition.

In various embodiments, the amount of polymer (e.g. latex) present is in the range of from about 10 wt % to about 40 wt %, from about 12 wt % to about 38 wt %, from about 14 wt % to about 36 wt %, from about 16 wt % to about 34 wt %, from about 18 wt % to about 32 wt %, from about 20 wt % to about 30 wt %, from about 22 wt % to about 28 wt %, from about 24 wt % to about 26 wt or about 25 wt % of the composition.

The polymer (e.g. latex) may be designed to achieve a desired surface functionality. In various embodiments, the polymer (e.g. latex) is a polymer comprising one, two or more types of monomers. In various embodiments, the polymer (e.g. latex) is a copolymer comprising at least two different types of monomers, at least three different types of monomers, at least four different types of monomers, at least five different types of monomers or at least six different types of monomers. In other embodiments, the polymer (e.g. latex) is a polymer comprising one type of monomer. The monomers may be selected from styrene; acrylic acid and derivatives thereof; methacrylic acid and derivatives thereof; maleic acid and derivatives thereof; itaconic acid and derivatives thereof; acrylonitrile; methacrylonitrile; butadiene; vinylidene chloride; vinyl acetate and derivatives thereof; acetic acid and derivatives thereof; and combinations thereof. In various embodiments, the acrylic acid derivative thereof comprises esters and amides (for e.g. N-methylolamides) of acrylic acid such as methyl acrylate, ethyl acrylate, butyl acrylate, 2-ethylhexyl acrylate (2EHA), N,N,dimethylacrylamide (NNDMA); the methacrylic acid derivative thereof comprises esters and amides of methacrylic acid such as methyl methacrylate (MMA) and (hydroxyethyl) methacrylate (HEMA); and the acetic acid derivative comprises esters and amides of acetic acid such as vinyl acetate. Advantageously, in various embodiments, the polymer (e.g. latex) to be used in the composition can be synthesized from readily available monomers. It will be appreciated that any latex polymer that can be obtained from commercial providers may also be used in embodiments of the composition disclosed herein. It will also be appreciated that the composition disclosed herein can be formulated with the knowledge one or more of the following three feature(s): (1) Structure of the interacting groups on the polymer (e.g. latex); (2) Deconvoluted IR spectra of the film with selected interacting nanoparticles; and (3) Tg jump pattern of the film with selected interacting nanoparticles.

In various embodiments, latex may be substituted/replaced with a water soluble polymer. In various embodiments, the water soluble polymer is poly(vinyl alcohol) (PVA). A PVA film may be used to show nanoconfinement effect in aqueous systems before performing on actual latex particle(s). Advantageously, the polymer film formed via nanoconfinement effect shows superior properties such as higher thermal stability and higher Tg.

In various embodiments, the polymer (e.g. latex) is in the form of a stable dispersion of polymeric particles that has been emulsified with one or more surfactants in an aqueous medium. Any suitable surfactant that effectively stabilizes polymer (e.g. latex) particles may be used in embodiments of the composition disclosed herein. The surfactant(s) may be selected from anionic surfactants, cationic surfactants, amphoteric surfactants or neutral/non-ionic surfactants. For example, the surfactant(s) may be selected from anionic surfactants such as carboxylic or sulfonic acid slats, cationic surfactants such as salts of long chain amines, amphoteric surfactants such as N-alkyl betaines/sulphobetaines, N-alkyl aminopropionic acids or imidazolium carboxylates and neutral surfactants such as alcohol ethoxylates or ethylene oxide propylene oxide copolymers. In various embodiments, the surfactant is selected from the group consisting of sodium dodecyl sulfate (SDS), ammonium lauryl sulfate (ALS), cethyl trimethyl ammonium bromide (CTABr), lauryl alcohol ethylene oxide and stearyl alcohol ethylene oxide.

In various embodiments, the polymer (e.g. latex) comprises a solid content of from about 10 wt % to about 65 wt %, from about 15 wt % to about 60 wt %, from about 20 wt % to about 55 wt %, from about 25 wt % to about 50 wt %, from about 30 wt % to about 45 wt %, or from about 35 wt % to about 40 wt %.

The polymer (e.g. latex) may be designed to achieve a desired size. In various embodiments, the polymer (e.g. latex) has a particle size of from about 10 nm to about 600 nm, from about 20 nm to about 580 nm, from about 30 nm to about 560 nm, from about 40 nm to about 540 nm, from about 50 nm to about 520 nm, from about 60 nm to about 500 nm, from about 70 nm to about 480 nm, from about 80 nm to about 460 nm, from about 90 nm to about 440 nm, from about 100 nm to about 420 nm, from about 120 nm to about 400 nm, from about 140 nm to about 380 nm, from about 160 nm to about 360 nm, from about 180 nm to about 340 nm, from about 200 nm to about 320 nm, from about 220 nm to about 300 nm, from about 240 nm to about 280 nm or about 260 nm.

In various embodiments, the polymer (e.g. latex) has a glass transition temperature in the range of from about 1.0° C. to about 40.0° C., from about 5.0° C. to about 35.0° C., from about 10.0° C. to about 30.0° C., from about 15.0° C. to about 25.0° C., or about 20.0° C.

In various embodiments, the polymer (e.g. latex) has a weight average molecular weight (Mw) in the range of from about 10,000 g/mol to about 500,000 g/mol, from about 20,000 g/mol to about 450,000 g/mol, from about 30,000 g/mol to about 400,000 g/mol, from about 40,000 g/mol to about 350,000 g/mol, from about 50,000 g/mol to about 300,000 g/mol, from about 60,000 g/mol to about 250,000 g/mol, from about 70,000 g/mol to about 200,000 g/mol, from about 80,000 g/mol to about 150,000 g/mol or from about 90,000 g/mol to about 100,000 g/mol, wherein the weight average molecular weight is determined by gel permeation chromatography (GPC) using tetrahydrofuran (THF) calibration.

In various embodiments, the polymer (e.g. latex) has a polydispersity index (Mw/Mn) in the range of from about 1.0 to about 15.0, from about 1.5 to about 14.5, from about 2.0 to about 14.0, from about 2.5 to about 13.5, from about 3.0 to about 13.0, from about 3.5 to about 12.5, from about 4.0 to about 12.0, from about 4.5 to about 11.5, from about 5.0 to about 11.0, from about 5.5 to about 10.5, from about 6.0 to about 10.0, from about 6.5 to about 9.5, from about 7.0 to about 9.0, from about 7.5 to about 8.5 or about 8.0, wherein the polydispersity index is determined by gel permeation chromatography (GPC) using tetrahydrofuran (THF) calibration. Detection of polymer (e.g. latex) may be carried by analysing the composition using cryo-transmission electron microscopy.

In various embodiments, the polymer (e.g. latex) is not a multistage polymer or multistage latex.

There is also provided a method of preparing a polymer (e.g. latex) disclosed herein, the method comprising mixing one or more surfactant with one or more buffer in water to form a surfactant mixture; adding one or more initiator to said surfactant mixture to form a surfactant-initiator mixture; and dispersing or emulsifying a monomer mixture in said surfactant-initiator mixture to form a stable dispersion of polymer (e.g. latex) particles.

In various embodiments, the mixing step is performed at an elevated temperature of from about 30° C. to about 120° C., from about 35° C. to about 115° C., 40° C. to about 110° C., from about 45° C. to about 105° C., from about 50° C. to about 100° C., from about 55° C. to about 95° C., from about 60° C. to about 90° C., from about 65° C. to about 85° C., from about 70° C. to about 80° C., or about 75° C.

In various embodiments, the composition is suitable for use as a paint composition or paint formulation. In various embodiments, the paint composition or paint formulation further comprises pigments and/or fillers, wherein the pigments (e.g. inorganic pigments) and/or fillers (e.g. inorganic fillers) are different from the inorganic particles/plasticizer substitute disclosed herein. As will be appreciated, in various embodiments, pigments (e.g. inorganic pigments) and/or fillers (e.g. inorganic fillers) are different from the inorganic nanoparticles/plasticizer substitute/alternative at least in that the plasticizing effect is conferred by inorganic nanoparticles while on the other hand, other effects (such as color, hiding power etc.) are conferred by other inorganic particles/pigments/fillers.

In various embodiments, the amount of pigments and/or fillers present is in the range of from about 10 wt % (for example, for very high gloss coatings) to about 70 wt % (for example, for high polyvinyl chloride (PVC) exterior coatings), from about 15 wt % to about 65 wt %, from about 20 wt % to about 60 wt %, from about 25 wt % to about 55 wt %, from about 30 wt % to about 50 wt %, from about 35 wt % to about 45 wt % or about 40 wt % of the composition.

In various embodiments, the pigments and/or fillers are selected from the group consisting of titania/TiO₂, limestone (for e.g. CaCO₃), clay (for e.g. cloisite Na⁺), silica, sodium carbonate, saw dust, cellulose power and the like and combinations thereof.

In various embodiments, the paint composition further comprises one or more of wetting agent/surfactant, thickener/thickening agent, base, defoamer/anti-foaming agent and dispersant/dispersing agent. In some embodiments, the dispersant/dispersing agent is not the same as the plasticizers described herein. Any suitable wetting agent/surfactant, thickener/thickening agent, base, defoamer/anti-foaming agent and dispersant/dispersing agent that effectively serve their respective functions may be used in embodiments of the composition disclosed herein. In some embodiments, the paint composition or coating formulation comprises/consists one or more of the following: nanoadditives such as silica; wetting agents; thickener (clay); ammonia; defoamer (BYK014); dispersant (BYK154); TiO₂ (Tronox); CaCO₃; cloisite Na⁺; and latex. In various embodiments, the wetting agent/surfactant, thickener/thickening agent, base, defoamer/anti-foaming agent and dispersant/dispersing agent are not small organic compound(s).

In various embodiments, the composition comprises/consists essentially of/consists of polymer (e.g. latex); inorganic particles/inorganic nanoparticles; water/aqueous medium/aqueous buffer and optionally one or more of pigments and/or fillers; wetting agent/surfactant, thickener/thickening agent; base, defoamer/anti-foaming agent; and/or dispersant/dispersing agent.

In various embodiments, the composition is substantially/completely devoid of or substantially/completely free of chemical crosslinks.

In various embodiments, the composition is substantially/completely devoid of or substantially/completely free of low volatility, non-phthalate plasticizer/coalescent blend.

In various embodiments, the composition is substantially/completely devoid of or substantially/completely free of fatty acids and their blends. As may be appreciated, fatty acids, which may be added as low odor VOC-free coalescence aids in polymer (e.g. latex) paints, are low molecular weight and accordingly, compositions containing fatty acids cannot be considered as SOC free.

In various embodiments, the composition is substantially/completely devoid of or substantially/completely free of reactive coalescence. As may be appreciated, unreacted groups resulting from reactive coalescence, which may be added in compositions to increase the glass transition for the purposes of creating a better film, are considered as VOC.

In various embodiments, zero or substantially low amounts of VOC is detected in the composition when the composition is analysed using gas chromatography.

There is also provided a film comprising polymer (e.g. latex) non-covalently bonded to inorganic particles, wherein the inorganic particles are configured/adapted to or capable of interacting with the polymer (e.g. latex) to cause an increase/jump in glass transition temperature (Tg) during formation of the film from the composition disclosed herein.

In various embodiments, the film has one or more of the following properties: odourless, non-tacky, non-sticky, excellent resistance to scrub, excellent resistance to abrasion, excellent resistance to washing, low or zero wetting, low water vapour transmission rate under dry conditions, chemically and/or physically stable, excellent resistance towards natural exposure/weathering.

In various embodiments, the film is a water-based acrylic coating. In various embodiments, the water-based acrylic coating is protective and/or non-tacky for exterior and interior coatings of metal, concrete and wood.

In various embodiments, the film is capable of resisting one, more than one, more than two, more than three, more than four or more than five wet scrub cycles as compared to a conventional film that is prepared in the absence of inorganic particles/plasticizer substitute.

In various embodiments, the film has a glass transition temperature in the range of from about 15.0° C. to about 40.0° C., from about 16.0° C. to about 39.0° C., from about 17.0° C. to about 38.0° C., from about 18.0° C. to about 37.0° C., from about 19.0° C. to about 36.0° C., from about 20.0° C. to about 35.0° C., from about 21.0° C. to about 34.0° C., from about 22.0° C. to about 33.0° C., from about 23.0° C. to about 32.0° C., from about 24.0° C. to about 31.0° C., from about 25.0° C. to about 30.0° C., from about 26.0° C. to about 29.0° C., or from about 27.0° C. to about 28.0° C.

There is also provided a method of preparing a film disclosed herein, the method comprising mixing inorganic particles, aqueous medium and optionally one or more of pigment, filler, wetting agent, thickening agent, base, anti-foaming agent, and dispersing agent, to form a mill base; and mixing said mill base with polymer (e.g. latex) to form a paint composition.

In various embodiments, the step of mixing the inorganic particles, aqueous medium and optionally one or more of pigment, filler, wetting agent, thickening agent, base, anti-foaming agent, and dispersing agent, to form a mill base comprises stirring the mixture until the particle size is less than about 50 μm, less than about 45 μm, less than about 40 μm, less than about 35 μm, less than about 30 μm, less than about 25 μm, less than about 20 μm, less than about 15 μm, less than about 10 μm, less than about 5 μm or less than about 1 μm as determined by a Hegman gauge.

In various embodiments, the method further comprises applying the paint composition on/over a substrate; and optionally curing the paint composition to form a film on/over the substrate.

Various embodiments of the method disclosed herein do not require a multistage polymer (e.g. multistage latex) or any other extra morphological features such as core-shell or interpenetrating polymers etc. in the polymer (e.g. latex). In various embodiments, the presently disclosed approach is novel and more versatile than conventional methods as many different types of polymers (e.g. latex) and inorganics/inorganic particles may be used.

Advantageously, in various embodiments, the method has a low production cost and/or is friendly to the environment. In various embodiments, the method is a water-based method and does not require harmful small organic molecules and compounds, thereby reducing health risks for workers and protecting the environment. It will be appreciated that conventional methods that use plasticizer in their compositions have high production cost as plasticizer is an expensive component which takes up about 10% of the composition in such known methods. By completely avoiding plasticizer through the unique application of a nanoconfinement effect to create plasticizer free formulation, embodiments of the method disclosed herein not only enjoy health benefits but also economic benefits as well.

There is also provided a kit comprising a polymer (e.g. latex) and a mill base separately stored from the polymer (e.g. latex) and configured to be mixed with the polymer (e.g. latex), the mill base comprising inorganic particles, an aqueous medium and optionally one or more of pigment, filler, wetting agent, surfactant, thickener, thickening agent, base, defoamer, anti-foaming agent, dispersant, and dispersing agent, wherein the inorganic particles are configured/adapted to or capable of interacting with the polymer (e.g. latex) to cause an increase/jump in glass transition temperature (Tg) during formation of the film from the composition disclosed herein.

There is also provided a coated substrate comprising a layer of the composition disclosed herein applied on/over a surface of the substrate. In various embodiments, the substrate is selected from a wide range of materials such as concrete, metal, wood, glass, plastic, fabric or combinations thereof.

In various embodiments, the presently disclosed composition is not a caulking sealant. In various embodiments, the presently disclosed method creates a film, not a filler.

In various embodiments, the presently disclosed method or composition does not involve modification of the polymer structure of the binder. In various embodiments therefore, the composition/coating formulation is not application specific, i.e. the chemistry behind the binder formulation may be compatible with conventional filler materials required for paint formulation. In various embodiments, the presently disclosed method does not involve complicated processes, thereby making it attractive to industries as no significant renovation to running production plants may be required.

In various embodiments, the presently disclosed method does not require any critical industrial modification or set up in production plant which allows the presently disclosed method to be readily adopted by industries. Embodiments of the present disclosure reduce the production costs as there is no additional cost of expensive film forming agent, coalescing agent or plasticizer.

In some embodiments, the paint is formulated using conventional inorganic materials like TiO₂ pigment (Tronox), Color pigment (Chemlink Pacific Pte Ltd, Shepherd) and the performance is compared with commercial benchmark. Advantageously, it is observed that the performance of the presently disclosed plasticizer free paint is comparable or even better than commercial benchmark.

In various embodiments, the composition/paint composition/coating formulation/film/kit/coated substrate is odor free and is therefore versatile for use in both interior and exterior applications.

### BRIEF DESCRIPTION OF FIGURES

FIG. 1 is a graph showing changes in the glass transition temperature (Tg) with time for a plasticizer-based system in a conventional approach, where a plasticizer is working as a solvent.

FIG. 2 is a graph showing changes in the glass transition temperature (Tg) with time for a plasticizer-free system designed in accordance with various embodiments disclosed herein.

FIG. 3A is a graph showing the particle size (d) in nm of exemplary latex particles designed in accordance with various embodiments disclosed herein, as measured by dynamic light scattering (DLS). Em3-80deg is the sample name of the latex used in the experiment. 4, 5 and 6 represents three runs of the DLS experiments.

FIG. 3B is a graph showing the zeta potential measurement in mV of exemplary latex particles designed in accordance with various embodiments disclosed herein, as measured by dynamic light scattering (DLS). Emulsions 11, 12 and 13 represent repetition of zeta potential measurements of the latex sample named Em3-80deg.

FIG. 4A and FIG. 4B show cryo-transmission electron microscopic (Cryo-TEM) images of exemplary latex particles designed in accordance with various embodiments disclosed herein. The scale bar represents 0.2 μm. FIG. 4C shows a scanning electron microscopic (SEM) image of exemplary latex particles designed in accordance with various embodiments disclosed herein. The scale bar represents 100 nm.

FIG. 5A is a graph showing the glass transition temperature (Tg) of no. 1 latex and nanocomposites loaded with varying wt % of SiO₂. The average size of the fumed silica used is 7 nm.

FIG. 5B is a graph showing the glass transition temperature (Tg) of no. 1 latex and nanocomposites loaded with varying wt % of SiO₂. The average size of the fumed silica used is 200 nm.

FIG. 6 is a graph showing the glass transition temperature (Tg) as a function of SiO₂ loading for a fumed silica:poly(vinyl acetate) (PVA) system, as measured with differential scanning calorimeter (DSC) and dynamic mechanical analysis (DMA).

FIG. 7 is a graph showing the extent of hydrogen bonding as a function of SiO₂ loading for a fumed silica:PVA system.

FIG. 8 shows photographs of surface coatings that have undergone wet abrasion scrub resistance tests. FIG. 8A shows surfaces coated with paint formulation F7H and F11H. FIG. 8B shows surfaces coated with paint formulation F7L and F11L.

FIG. 9 show photographs of paint film (A) containing F7L and paint film (B) containing F11L after a water droplet was put onto both films. After wiping off the water after 15 minutes, there was no water mark observed for both paint film (C) containing F7L and paint film (D) containing F11L

FIG. 10 show photographs obtained from print resistance test of paint formulations. FIG. 10A shows ASTM standard cotton. FIG. 10B shows ASTM standard cotton imprinted on F11L. FIG. 10C shows ASTM standard cotton imprinted on F11H. FIG. 10D shows the cotton being removed after the test, FIG. 10E and FIG. 10F show that no impression is found on F11L and F11H respectively.

FIG. 11 is a schematic flowchart 100 for illustrating the experiment set-up for testing the permeability of the paint coatings designed in accordance with various embodiments disclosed herein.

FIG. 12 is a graph showing mass against time for 10 cm² Nippon Weatherbond and 25 cm² Nippon Roofguard permeability films.

FIG. 13 is a graph showing mass against time for 10 cm² Nippon Aqua Bodelac and 25 cm² Nippon Weatherbond permeability films.

FIG. 14 is a graph showing mass against time for Formulation F11L permeability film.

FIG. 15 is a photograph of weather/exposure racks set up at an experimental site in Nanyang Technological University (NTU) used for testing natural exposure.

FIG. 16 shows photographs obtained from the weathering tests performed on formulations designed in accordance with various embodiments disclosed herein.

FIG. 17 shows an experimental set up 200 for performing emulsion polymerisation 202 during latex synthesis.

FIG. 18 shows a schematic diagram 300 for illustrating emulsion polymerisation.

FIG. 19 shows a transmission electron microscopic (TEM) image of silica used in the method designed in accordance with various embodiments disclosed herein. The scale bar represents 20 nm.

FIG. 20 is a graph showing the glass transition temperature (Tg) of exemplary latex designed in accordance with various embodiments disclosed herein and nanocomposites loaded with varying wt % of SiO₂ nanoparticles.

FIG. 21 shows a schematic diagram 400 for illustrating a method of preparing paint formulation designed in accordance with various embodiments disclosed herein.

FIG. 22 shows photographs of films formed by the paint formulations designed in accordance with various embodiments disclosed herein.

FIG. 23 shows photographs of surface coatings that have undergone wet abrasion scrub resistance tests. FIG. 23A shows surface coated with blank. FIG. 23B shows surface coated with an ICES plasticizer free paint formulation designed in accordance with various embodiments disclosed herein (hereinafter referred to as “iPF Paint”).

FIG. 24 shows photographs of paint films that have undergone 72 hours of QUV exposure test. FIG. 24A shows Nippon Aqua Bodelac paint film. FIG. 24B shows Dulux Gloss paint film.

FIG. 25 shows photographs of paint films before and after 72 hours of QUV exposure test. FIG. 25A shows blank. FIG. 25B shows ICES plasticizer free paint formulation designed in accordance with various embodiments disclosed herein (hereinafter referred to as “iPF Paint”). FIG. 25C shows ICES plasticizer free colour paint formulation designed in accordance with various embodiments disclosed herein (hereinafter referred to as “iPF Colour Paint”).

FIG. 26 shows photographs of paint films after 3 months of natural exposure/weathering. FIG. 26A shows Nippon Aqua Bodelac paint film. FIG. 26B shows Dulux Gloss paint film.

FIG. 27 shows photographs of paint films on concrete and metal substrates after 3 months of natural exposure/weathering. FIG. 27A shows blank. FIG. 27B shows ICES plasticizer free paint formulation designed in accordance with various embodiments disclosed herein (hereinafter referred to as “iPF Paint”).

FIG. 28 shows photographs obtained from the weathering tests performed on commercial formulations and formulations designed in accordance with various embodiments disclosed herein. FIG. 28A shows Dulux Gloss. FIG. 28B shows Aqua Bodelac. FIG. 28C and FIG. 28D shows F1 with and without primer respectively. FIG. 28E shows F2 with primer. The primer used was commercial primer Nippon Bodelac 9000 Undercoat. Normally, the makeup of these primers are 20-30% polymer, 60-80% water and 2-5% additive agents. It will be appreciated that latex dispersion may also be used as the primer.

### EXAMPLES

Example embodiments of the disclosure will be better understood and readily apparent to one of ordinary skill in the art from the following examples, tables and if applicable, in conjunction with the figures. It should be appreciated that other modifications related to structural, and chemical changes may be made without deviating from the scope of the invention. Example embodiments are not necessarily mutually exclusive as some may be combined with one or more embodiments to form new example embodiments. The example embodiments should not be construed as limiting the scope of the disclosure.

In the following examples, the inventors show that embodiments of the presently disclosed method are capable of synthesizing small organic compounds (SOC) and/or plasticizer free formulations by using interaction between presently designed polymer binders in waterborne coating and commercially available nano-additives.

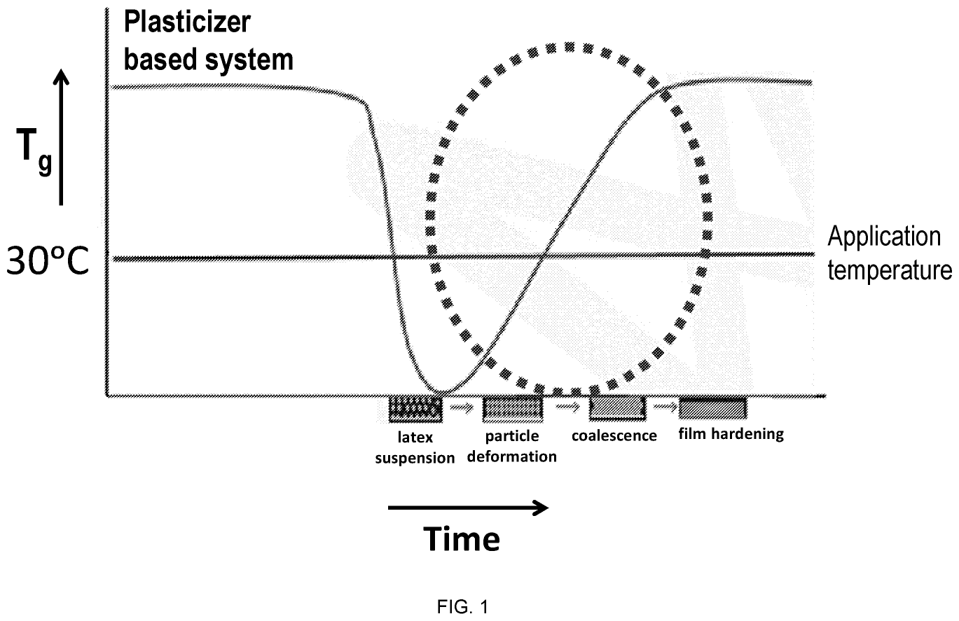

As will be shown in the following examples, formulations designed in accordance with various embodiments disclosed herein are designed and created using nanoconfinement effect. This concept is somewhat different from the evaporative effect used in plasticizer-based system of conventional methods which is illustrated in FIG. 1.

FIG. 1 shows a glass transition temperature (Tg) vs. time graph for a plasticizer-based system in conventional methods. In such conventional methods, the plasticizer is typically added which will reduce the Tg to promote coalescence. When film formation is over, the plasticizer will evaporate, leading to a Tg jump. It will be appreciated by a person skilled in the art that this conventional technology is almost like a modified form of solvent based paint where the plasticizer is working as solvent. Therefore, as can be seen, the use of SOCs or volatile organic compounds (VOCs) in the form of plasticizers remains necessary in current methods used to prepare coating formulations.

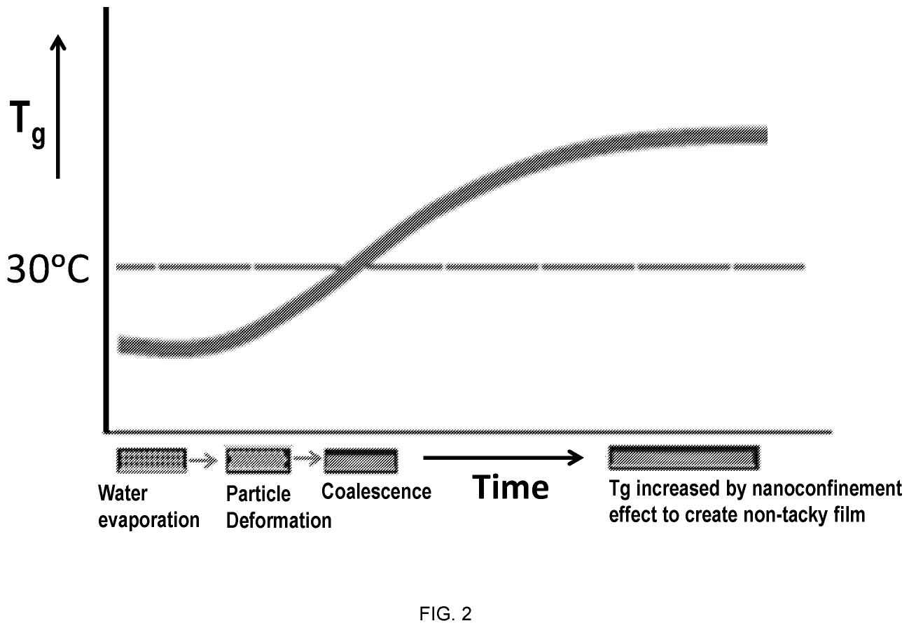

On the contrary, the concept/underlying principle of using the nanoconfinement effect for the formulations designed in accordance with various embodiments disclosed herein is explained in FIG. 2.

Referring to FIG. 2, Tg of the latex designed in accordance with various embodiments disclosed herein is low before film formation. Due to nanoconfinement effect, Tg increases upon film formation. For example, a low Tg binder may be used which can undergo coalescence on evaporation of water. Physical interaction(s) between binder and inorganics may cause the Tg jump to provide a non-tacky film. Importantly, the idea of the presently disclosed method is not based on any evaporative solvent. The presently disclosed method could, therefore, provide a breakthrough technology for designing SOC and/or plasticizer free water-based paints and/or polymer films.

### Example 1: Latex Synthesis

### 1.1. Synthesis Procedure of Latex

The general procedure for synthesizing latex in accordance with various embodiments disclosed herein include: mixing a mixture containing two or more monomers with a surfactant, buffer and initiator.

Total emulsion to be made is 200 mL with solid content 30%. Total monomer required is 60 mL. Table 1 shows the composition and weight of the monomer mixture used for synthesis of latex.

TABLE 1
Composition and Weight of Monomer Mixture

| Components | Weight (%) | Weight (g) |
|---|---|---|
| Styrene (Sty) | 26 | 14.37 |
| 2-ethyl hexyl acrylate (2EHA) | 38 | 21.01 |
| Methyl methacrylate (MMA) | 30 | 16.58 |
| Methacrylic acid (MAA) | 6 | 3.32 |

Density of composition mixture is:

0.26×0.906 (Sty)+0.38×0.885 (2EHA)+0.3×0.936 (MMA)+0.06×1.015 (MAA)=0.92136 g/mL

(60 mL=60×0.92136=55.2816 gram monomer mixture)

In this example, sodium dodecyl sulfate (SDS) is used as the surfactant, sodium bicarbonate is used as buffer and ammonium persulfate is used as the initiator for emulsion polymerisation. 4 wt % of surfactant and 2 wt % of sodium bicarbonate with respect to the monomer mixture is first added to argon-bubbled deionized water. The mixture is stirred and heated to 70-80° C. Then pre-dissolved ammonium persulfate (APS) of 1 wt % with respect to the monomer mixture is added to the mixture, followed by feeding the monomer mixture into the solution at 0.2 mL/min The reaction is allowed to stir for 24 h to consume all the monomers. The mixture is filtered after the reaction, the dispersion is stable. The total solid content of the latex system was measured to be 31.76%.

### 1.2. Characterization of Latex

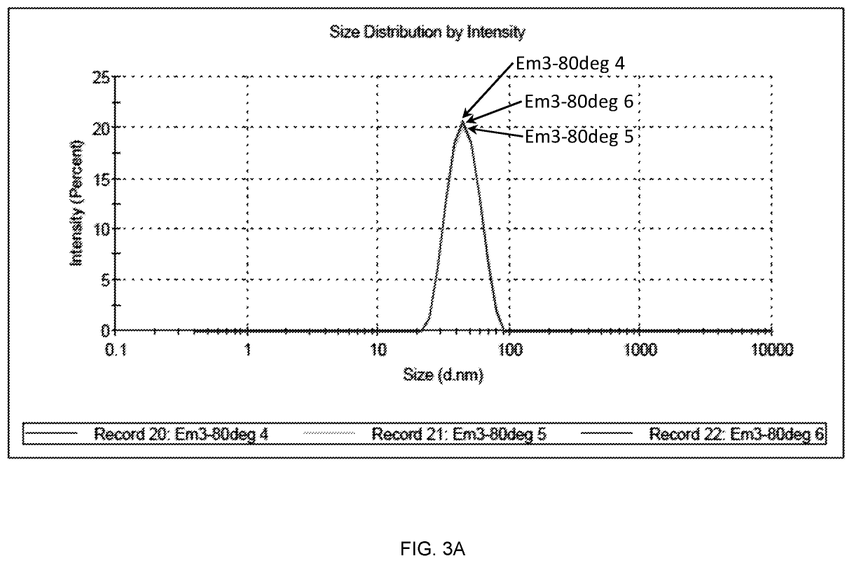

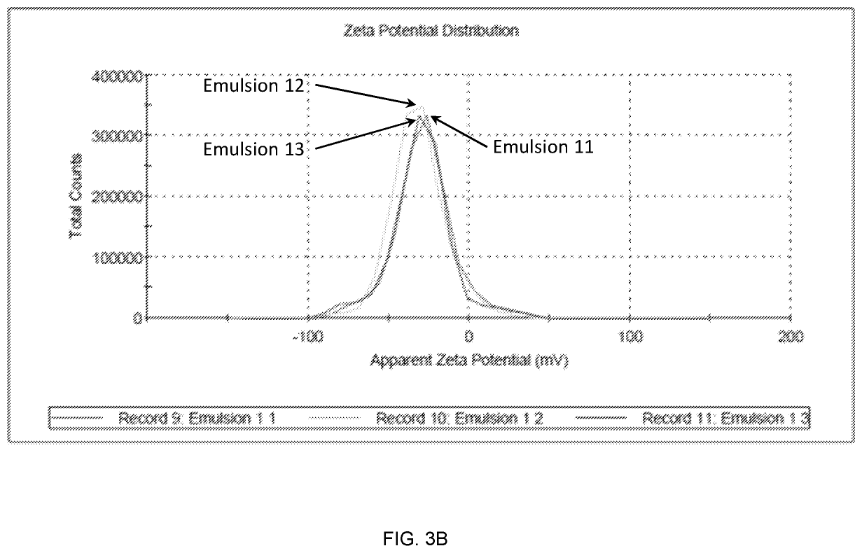

The latex dispersion is then measured for particle size and zeta-potential by dynamic light scattering (DLS). The characterisation results are provided in FIG. 3A and FIG. 3B respectively. As shown, the size of the latex particle is 42.98 nm. Zeta potential of the dispersion is 28.2 mV.

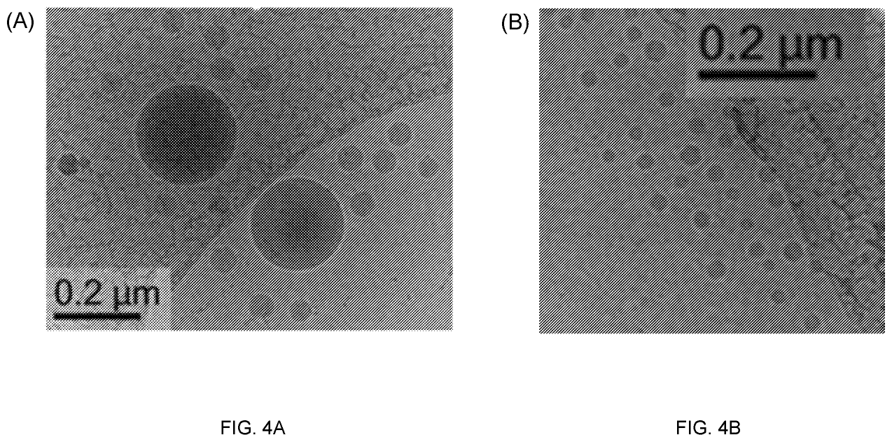

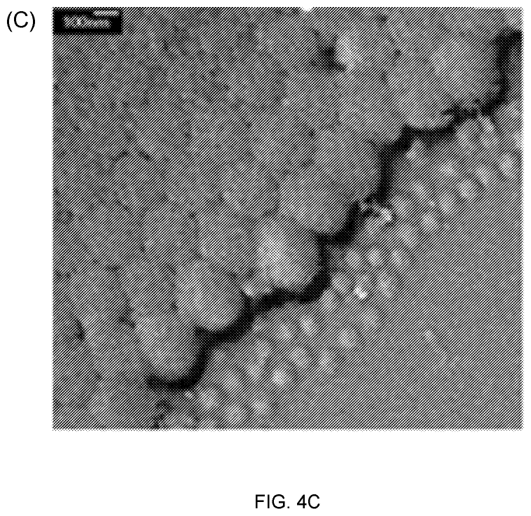

In addition to these characterizations, cryo-transmission electron microscopic (TEM) and scanning electron microscopic images were also taken to confirm the particle size information that is obtained from DLS, as shown in FIG. 4A, FIG. 4B and FIG. 4C.

After characterization was completed, the system was scaled up to 1 litre and used in formulations of paint.

### 1.3. Latex Systems Synthesized in this Example

A variety of latex systems were prepared in accordance with the procedure described above for the study. A summary of the latex systems synthesized in this example is shown in Table 2.

TABLE 2
Summary of Synthesized Latex Systems

| | | Solid | | | | GPC (THF) | |
|---|---|---|---|---|---|---|---|
| Latex | | content | Diameter | Tg (° C.) | | Mol. Wt. | |
| No. | Composition* | (wt %) | (nm) | Fox eq. | DSC | (Mw) | Mw/Mn |
| 1 | Sty (26%), 2EHA (38%), | 30 | 42 | 28.7 | 19.89 | 78,807 | 3.9 |
| | MMA (30%), MAA (6%) | | | | | | |
| 2 | Sty (26%), 2EHA (38%), | 50 | 235 | 28.7 | 28.35 | 58,326 | 2.2 |
| | MMA (30%), MAA (6%) | | | | | | |
| 3 | Sty (26%), 2EHA (38%), | 50 | 97 | 28.7 | 33.9 | — | — |
| | MMA (30%), MAA (6%) | | | | | | |
| 4 | Sty (26%), 2EHA (48%), | 30 | 41 | 11.3 | 4.42 | — | — |
| | MMA (20%), MAA (6%) | | | | | | |
| 5 | Sty (26%), 2EHA (38%), | 25 | 42 | 22.1 | 23.28 | 166,904 | 7.0 |
| | MMA (30%), HEMA (6%) | | | | | | |
| 6 | Sty (26%), 2EHA (38%), | 35 | 443 | 22.9 | — | 154,347 | 6.1 |
| | MMA (30%), NNDMA (6%) | | | | | | |
| 7 | Sty (26%), 2EHA (38%), | 30 | 72 | 20.1 | — | 186,065 | 7.1 |
| | MMA (30%), VA (6%) | | | | | | |
| 8 | Sty (28%), 2EHA (40%), | 30 | 55 | 20.1 | — | 346,186 | 12.4 |
| | MMA (32%), | | | | | | |

*Sty: styrene, 2EHA: 2-ethylhexyl acrylate, MMA: methyl methacrylate, MAA: methacrylic acid, HEMA: (hydroxyethyl) methacrylate, NNDMA: N,N,dimethyl acrylamide, VA: vinyl acetate

### Example 2: Tg Jump/Increase Via Nanoconfinement Effect

### 2.1. Proof of Concept

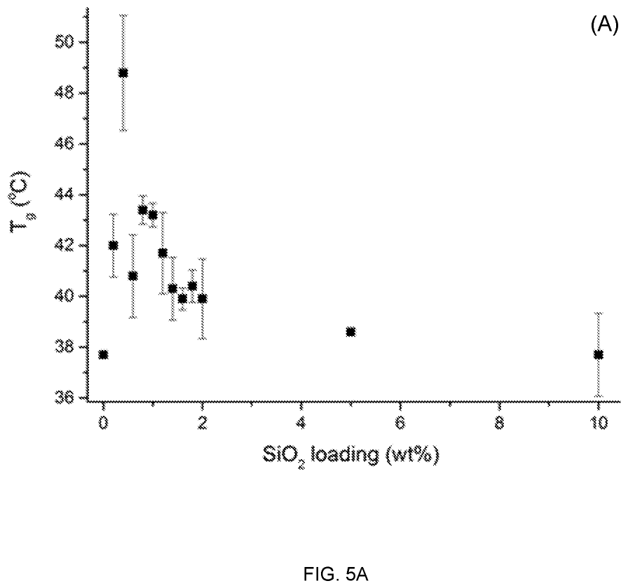

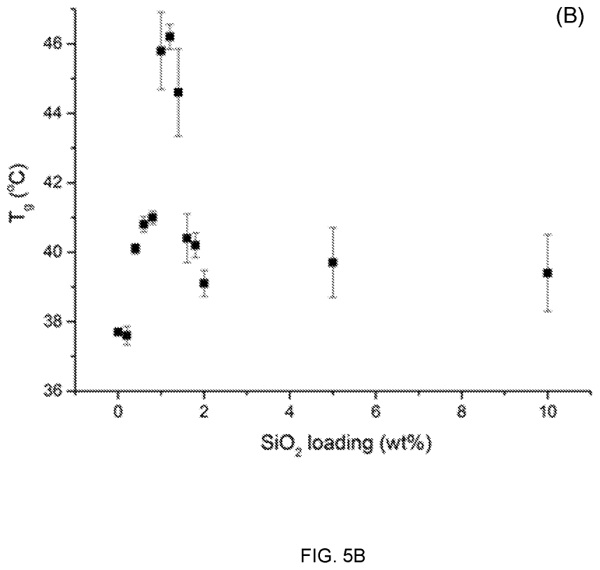

Proof of concept showing Tg jump was demonstrated by dynamic mechanical analysis (DMA) of films prepared by using an aqueous dispersion of the latex and various amounts of silica nanoparticles in the composite films (average size of fumed silica is 7 nm and 200 nm respectively), as provided in FIG. 5A and FIG. 5B. In this example, latex no. 1 of Table 1 is used. In the case of 7 nm fumed silica, the Tg value increased from the value of the pure latex (37.7° C.) to 48.8° C. by loading just 0.4 wt % SiO₂ (FIG. 5A). In the case of 200 nm fumed silica particles, the Tg increased in a similar fashion reaching a maximum of 46.2° C. at 1.6 wt % (FIG. 5B).

Without being bound by theory, this increase in Tg values to a maximum can be attributed to the interaction of copolymer chains and the surface functionality of the SiO₂ nanoparticles, which restricted the free movement of the copolymer chains. This is contrary to the common general knowledge of a technical person in the art. It is important to note that a normal practitioner in the field would be under the impression that by incorporating SiO₂ nanoparticles into the latex, the free volume of the copolymer chains will be increased, therefore imparting a decrease in Tg of the composite materials. This is according to the Flory-Fox equation which shows that an increase in free volume (as represented by the empirical parameter K), for a constant molecular weight, will decrease the glass transition temperature of the composite. Hence, it is surprising that at lower wt % loadings however, this effect was not as potent due to the fact that the SiO₂ nanoparticles were able to better accommodate themselves within the matrix. This ensured the maximum probability for interaction with the copolymer chains, which played a vital role in Tg increment of the nanocomposites. At further higher wt % loading of SiO₂ nanoparticles, the increase in free volume of the polymer chains might be beginning to show up and restricting the interactions between the latex and SiO₂ nanoparticles, which might be leading to the decreasing Tg from the maximum. As such, it can be concluded that SiO₂ is able to enhance the Tg of the composite through interfacial physical interaction, allowing it to reach a maximum up to a certain extent, which vary based on the loading of nanoparticles incorporated. The Tg increase observed in the latex-silica system forms a critical part of the presently disclosed invention.

In the next example, this phenomenon was utilized to create small molecule free paint formulations.

### 2.2. Tg Increase in Composite Films and Hydrogen Bonding Interaction

Experiments were conducted to study the Tg increase in composite films obtained from polymer solution with dispersed silica.

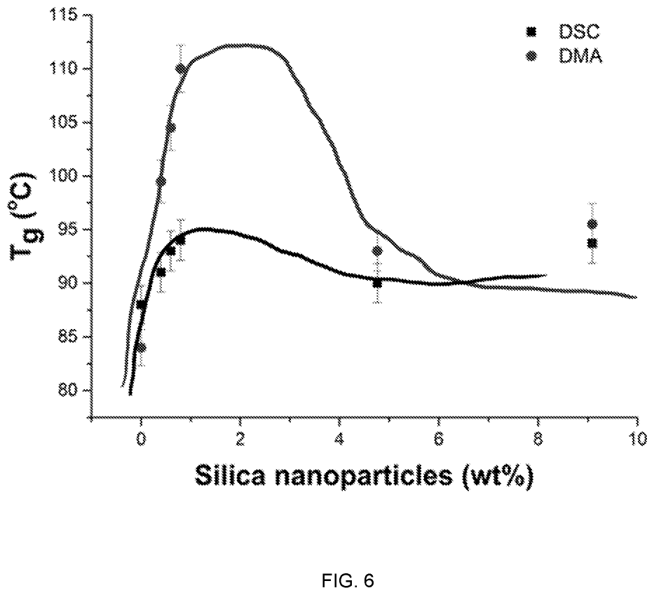

FIG. 6 is a graph showing the glass transition temperature (Tg) as a function of SiO₂loading for a fumed silica:poly(vinyl acetate) (PVA) system, as measured with differential scanning calorimeter (DSC) and dynamic mechanical analysis (DMA). It was observed that hydrogen bonding (H-bonding) interactions can create 10° C. to 15° C. Tg jump in different polymers.

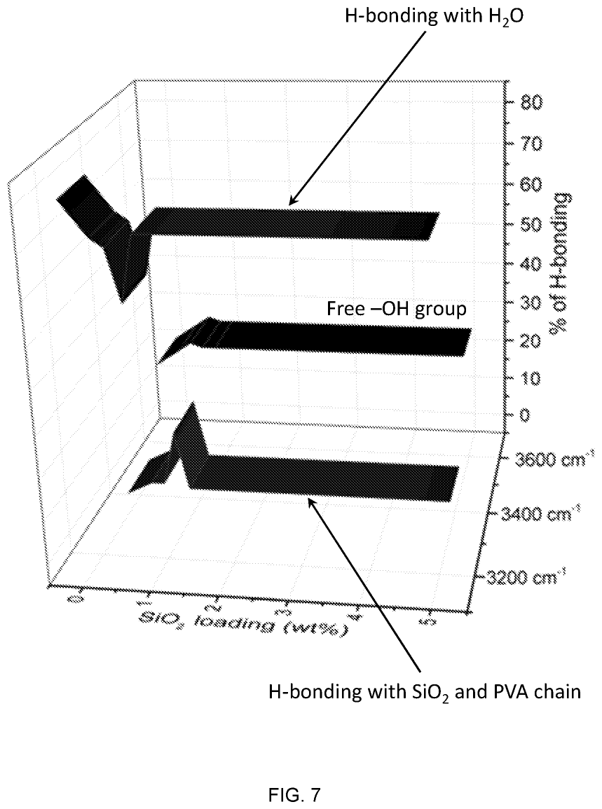

FIG. 7 is a graph showing the extent of hydrogen bonding as a function of SiO₂ loading for a fumed silica:PVA system.

It was found that hydrogen bonding interaction is the major factor influencing Tg increase.

### Example 3: Paint Formulation

Paint formulations were prepared using the latex examples synthesized in Example 1. The recipe for paint formulations based on relatively high Tg latex (Examples F7H, F9H, F10H, F11H) and relatively low Tg latex (Examples F7L, F9L, F10L, F11L) is detailed in Tables 3 and 4 respectively.

In Tables 3 and 4 below, ICES Additives 1, 2 and 3 are nano silica additives, more specifically, positively charged nanosilica having an average size of 7 nm in diameter. Nouryon's Levasil CC301, which is the commercial equivalent of the nanosilica additives may also be used. Defoamer is BYK-014, thickener is RHEOBYK-7610, wetting agent is BYK-333 and dispersant is BYK-154.

TABLE 3
Paint Formulation using Latex No. 1

| | Weight (g) | | | |
|---|---|---|---|---|
| Components | F7H | F9H | F10H | F11H |

Mill base

| | | | | | |
|---|---|---|---|---|---|
| 1 | Water | 296 | 236 | 176 | 176 |
| 2 | ICES Additive 1 | 0 | 0 | 0 | 50 |
| 3 | ICES Additive 2 | 0 | 0.72 | 0 | 0 |
| 4 | ICES Additive 3 | 0 | 0 | 2.1 | 0 |
| 5 | Wetting agent | 1 | 1 | 1 | 1 |
| 6 | Thickener | 0.6 | 0.6 | 0.6 | 0.6 |
| 7 | Ammonia (25%) | 2 drops | 2 drops | 2 drops | 2 drops |
| 8 | Defoamer | 0.5 | 0.5 | 0.5 | 0.5 |
| 9 | Dispersant | 2 | 2 | 2 | 2 |
| 10 | TiO₂ | 70 | 70 | 70 | 70 |
| 11 | Cloisite Na⁺ | 15 | 15 | 15 | 15 |

Let down

| | | | | | |
|---|---|---|---|---|---|
| 12 | Latex No. 1 | 142 | 142 | 142 | 142 |

TABLE 4
Paint Formulation using Latex No. 4

| | Weight (g) | | | |
|---|---|---|---|---|
| Components | F7L | F9L | F10L | F11L |

Mill base

| | | | | | |
|---|---|---|---|---|---|
| 1 | Water | 296 | 236 | 176 | 176 |
| 2 | ICES Additive 1 | 0 | 0 | 0 | 50 |
| 3 | ICES Additive 2 | 0 | 0.72 | 0 | 0 |
| 4 | ICES Additive 3 | 0 | 0 | 2.1 | 0 |
| 5 | Wetting agent | 1 | 1 | 1 | 1 |
| 6 | Thickener | 0.6 | 0.6 | 0.6 | 0.6 |
| 7 | Ammonia (25%) | 2 drops | 2 drops | 2 drops | 2 drops |
| 8 | Defoamer | 0.5 | 0.5 | 0.5 | 0.5 |
| 9 | Dispersant | 2 | 2 | 2 | 2 |
| 10 | TiO₂ | 70 | 70 | 70 | 70 |
| 11 | Cloisite Na⁺ | 15 | 15 | 15 | 15 |

Let down

| | | | | | |
|---|---|---|---|---|---|
| 12 | Latex No. 4 | 142 | 142 | 142 | 142 |

### 3.1. Method of Preparing Paint Formulation

60 mL water was added into an appropriate beaker and stirred at 400 rpm. Afterwards, wetting agent, thickener, ammonia, defoamer and dispersant were added consecutively to the water and the solution consistency changed and the mixture became slightly translucent. TiO₂ pigment was slowly added to the mixture next, then clay (Cloisite Na⁺) was added slowly with water added in between clay addition. This is to prevent the mixture from caking due to layered structure of clay and hence longer time taken to dissolve the clay structure. The mill base mixture was stirred at 2000 rpm for 3-4 hours. The mixture was stirred until the Hegman gauge particle size is less than 30 μm. The let-down process was started by pouring the mill base mixture into the latex and stirred at 800 rpm for 3 hours.

### 3.2. Testing

### 3.2.1. Comparison with Control Paint

### 3.2.1.1. Wet Abrasion Scrub Resistance (Cycles)

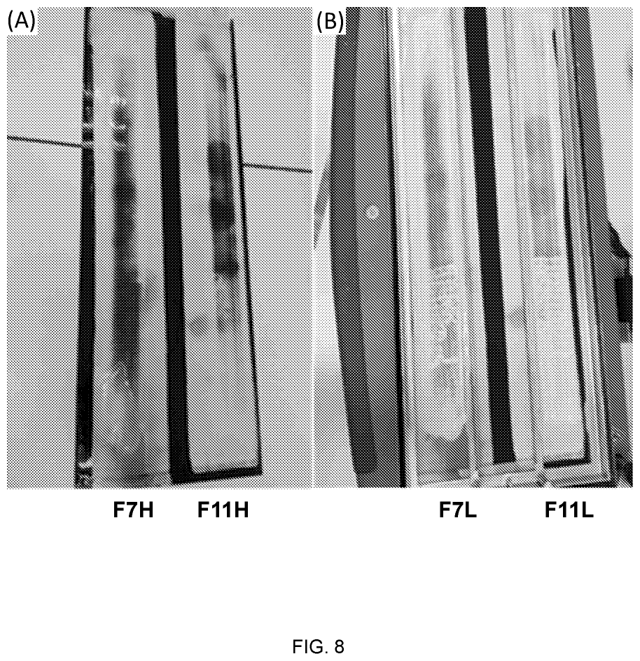

The technique often used to test scrub, abrasion and washability resistance of paint is through an accelerated method. It also provides idea for determining wear resistance of surface coatings, and also tests the performance of cleaning compounds. Paints containing low Tg binder (F7L and F11L) were tested in this method, alongside with paints containing high Tg binder (F7H and F11H) that were used as control paints. It was observed that F11L could resist more than twice wet scrub cycles compared to F7L (Table 5 and FIG. 8). In contrast, F11H does not show any considerable improvement in a similar testing compared to F7H. This result proves that ICES additive 1 is able to successfully enhance proper coalescing accompanied with Tg jump in F11L.

TABLE 5
Results of Wet Scrub Resistance (Cycles)
Wet Scrub Resistance (Cycles)

| F7H | F7L | F11H | F11L |
|---|---|---|---|
| 81 | 94 | 90 | 193 |

### 3.2.1.2. Water Mark Test

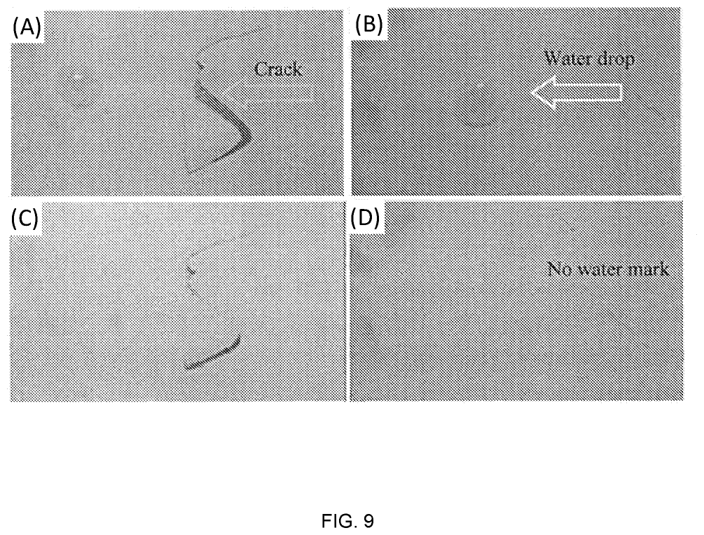

As one important application of the present disclosure was on exterior coatings, it was also highly important to ensure that the formulated paint film would not leave any stains upon contact with water. Water mark tests were conducted on paint films containing formulations F7L and F11L (FIG. 9).

1 ml of water was placed onto both samples (FIG. 9A and FIG. 9B) which were wiped off after 15 mins. No water marks were observed in both specimens (FIG. 9C and FIG. 9D). As such, it could be concluded that water soluble components of the formulation are not washed away nor had any wetting effect upon contact with water. This also helps to show that the physical interactions between the latex and inorganic particles were fully maximized as a result.

### 3.2.1.3. Print Resistance Test

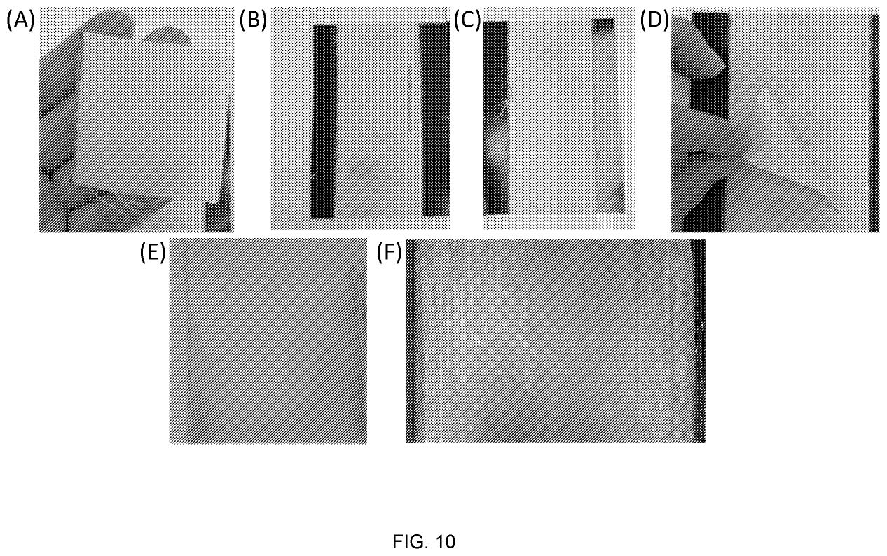

The print resistance tests were performed following ASTM D2064-91(2016) which basically test the ability of a coating to resist accidental imprint on it due to applied pressure on the coated surface, especially at higher temperature. On the other hand, this test is also important to describe the ability of the paint to resist its surface smoothness particularly in contact with rough texture. Interestingly, it was observed that both low and high Tg formulations are free from such issues and does not show any impression of the standard cotton texture even at a temperature of 90° C. (FIG. 10).

### 3.2.2. Comparison with Commercial Paint (Permeability)

Permeability testing is useful in providing quantitative information on the performance of the paint coatings and its ability in allowing or preventing water vapour from passing through under different permeability cup conditions—namely wet cup i.e. high humidity (between 93% and 50%) and dry cup i.e. low humidity (50% and 3%). For this experiment, humidity was evaluated using different paint coatings. Saturated ammonium dihydrogen phosphate solution for the wet cup method and anhydrous calcium chloride was used for the dry cup method.

### 3.2.3. Method for Performing Permeability Test

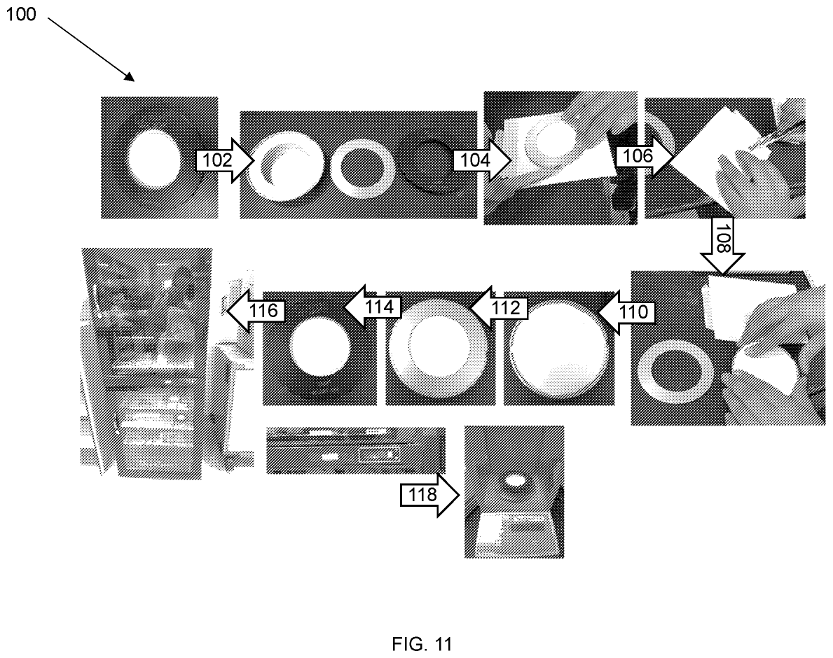

FIG. 11 is a schematic flowchart 100 for illustrating the experiment set-up for permeability testing of the paint coatings designed in accordance with various embodiments disclosed herein. At steps 102 to 104, two layers of coating were applied onto a release paper (Form RP-1k) using a 120μ KBar applicator and left to dry in a freely circulating air at (23±2)° C. and (50±5)% relative humidity. At steps 106 to 108, after drying, paint film was carefully removed from the release paper and cut to shape, according to the individual cup dimensions—10 cm² and 25 cm² and its thickness measured. At steps 110, 112 to 114, the paint film was then secured onto the permeability cup with the following conditions; dry cup (anhydrous calcium chloride) or wet cup (saturated ammonium dihydrogen phosphate solution). At step 116, test assembly was placed in a test enclosure maintained at (23±2)° C. and (50±5)% relative humidity. At step 118, the cup was weighed at different intervals to determine the loss or gain in mass and returned to the test enclosure to continue testing after weighing. The test is considered complete when three or more points lie in a straight line. This method is accurate for water vapour transmission rates of 680 g/(m²·d) and below.

### 3.3. Result

The following paint films were prepared for permeability testing:

1. Nippon Weatherbond

2. Nippon Roofguard

3. Nippon Aqua Bodelac

4. F11H Formulation

As wet cup permeability measures the loss of water vapour through the paint film, a general downward trend was observed. The inverse can be seen for dry cup permeability testing.

A best fit line was achieved based on the data collected from the experiment which passes through at least three points on the graph.

The water vapour transmission rate can be calculated as follows:

$$V = 24 \times ( \frac{p}{{p}_{0}} ) \times ( \frac{G}{A} ) \qquad ( 1 )$$

G—Rate of flow of water vapour, in grams per hour, through the test piece (g/h)

A—Area of the test piece through which the water vapour flows (m²)

p—Atmospheric pressure at place of measurement (Pa)

$$p = {p}_{0} - ( \frac{h}{8.5} ) ; \\ where {p}_{0} = 101325 Pa \qquad ( 2 )$$

h=height of lab above sea level (15 m for Singapore) (m)

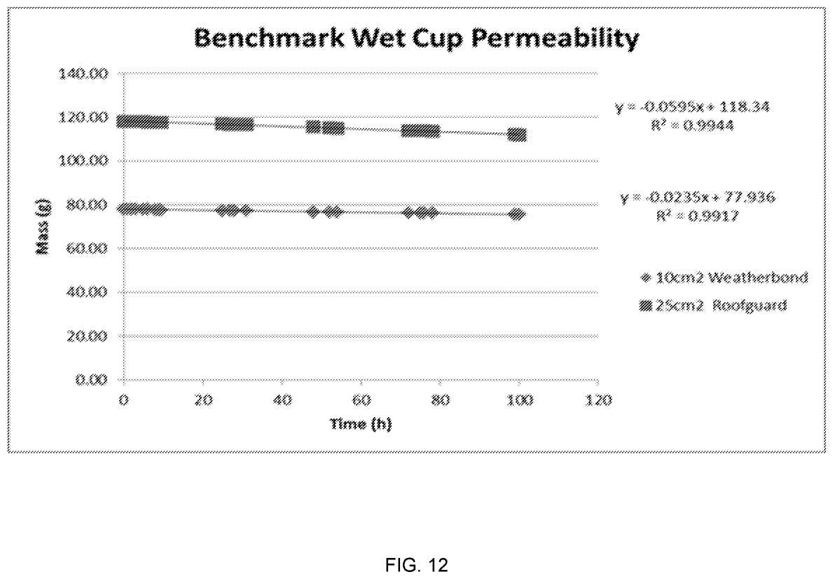

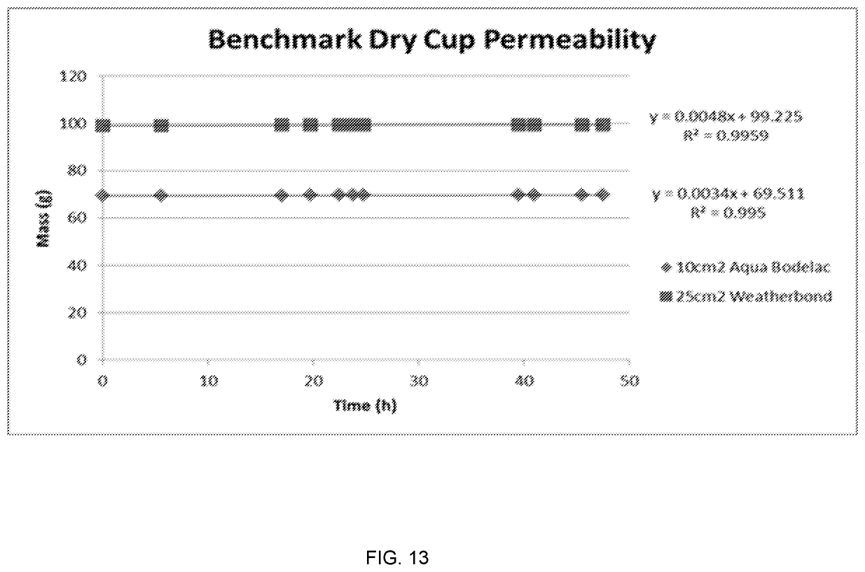

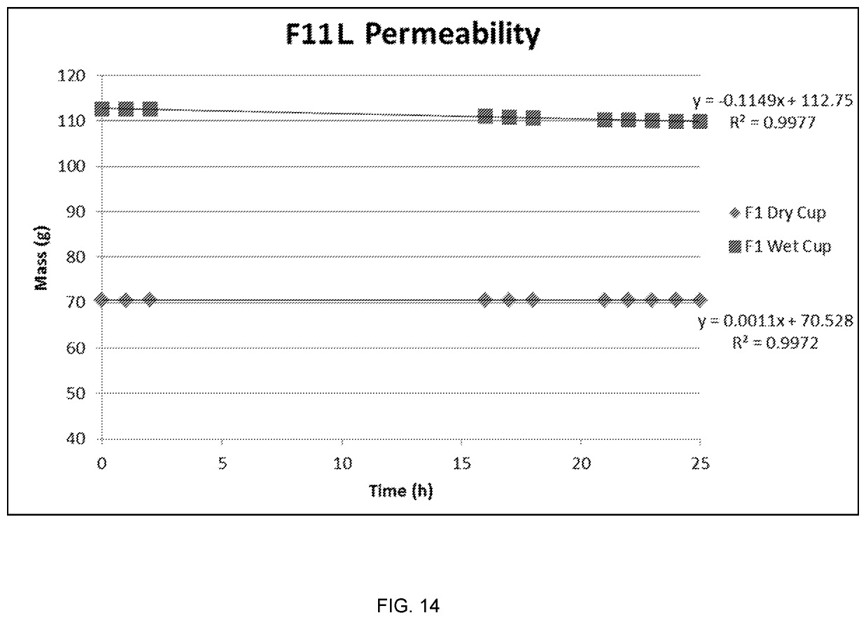

The results obtained are provided in Tables 6 to 8 and FIGS. 12 to 14 respectively.

TABLE 6
Wet Cup Permeability Calculations for Nippon
Weatherbond and Nippon Roofguard

| | Nippon | Nippon |
|---|---|---|
| Parameter | Weatherbond | Roofguard |
| Surface Area (cm²) | 10 (0.001) | 25 (0.0025) |
| Rate of Flow of Water | 0.0235 | 0.0595 |
| Vapour (G) (g/h) | | |
| Water Vapour Transmission | 564 | 571 |
| Rate (V) (g/m² · day) | | |

TABLE 7
Dry Cup Permeability Calculations for Nippon
Aqua Bodelac and Nippon Weatherbond

| | Nippon | Nippon |
|---|---|---|
| Parameter | Aqua Bodelac | Weatherbond |
| Surface Area (cm²) | 10 (0.001) | 25 (0.0025) |
| Rate of Flow of Water | 0.0034 | 0.0048 |
| Vapour (G) (g/h) | | |
| Water Vapour Transmission | 82 | 46 |
| Rate (V) (g/m² · day) | | |

TABLE 8
Dry and Wet Cup Permeability
Calculations for F1 Formulation

| | F11H | F11H |
|---|---|---|
| Parameter | Dry Cup | Wet Cup |
| Surface Area (cm²) | 10 (0.001) | 25 (0.0025) |
| Rate of Flow of Water | 0.0011 | 0.1149 |
| Vapour (G) (g/h) | | |
| Water Vapour Transmission | 26 | 1123 (>680) |
| Rate (V) (g/m² · day) | | |

### 3.3.1 Discussion

Based on the calculated values above, it was observed that the F11L formulation gave a much lower water vapour transmission rate under dry cup conditions as compared to both benchmark paints—Nippon Aqua Bodelac and Nippon Weatherbond. This shows that F11L formulation would perform better for applications where high relative humidity are not anticipated as compared to the two commercially available paints in the market.

### 3.4. Comparison with Commercial Paint (Weathering)

For the natural exposure/weathering tests, the inventors have designed an exposure rack that can be set at different angles such as 0°, 45° and 90°. The exposure rack complies with ISO 2810 [EN ISO Standard 2810, 2004, “Paints and varnishes. Natural weathering of coatings. Exposure and assessment,” European Committee for Standardization (CEN), ISBN 0 580 44141 5, http://www.bsigroup.com].

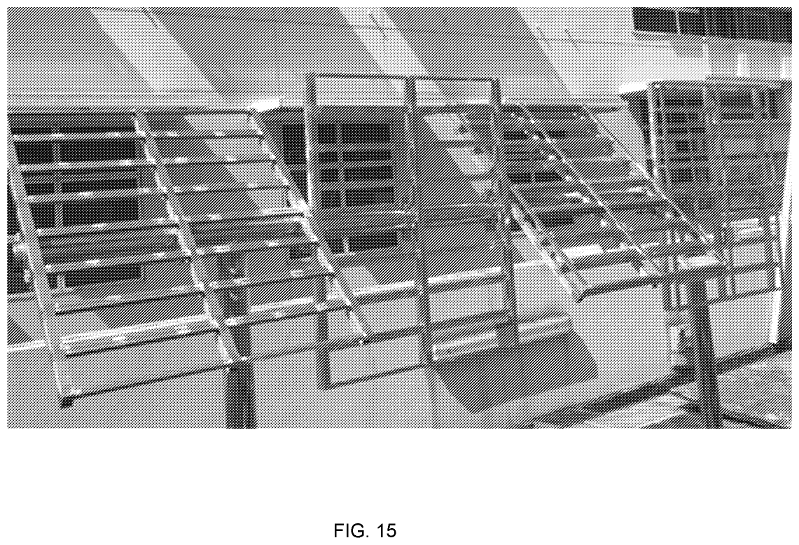

A picture of the exposure rack is shown in FIG. 15. The exposure rack can hold a metal and a concrete substrate. The plan for the test was that for each paint sample, 4 specimens are prepared. The specimen size is about 10 cm*12 cm (L*B) and one specimen was tested after every 3 months for a time span of 1 year. After the weathering tests, different defects such as chalking, cracking, blistering etc. were found. The tests for these defects and other properties were finalized, which are shown in Table 9 and have to be performed after the exposure. The tests are common for Accelerated Weathering as well and are in accordance with the ASTM D4857 [ASTM Standard D4587, 2011, “Standard Practice for Fluorescent UV-Condensation Exposures of Paint and Related Coatings,” American Society for Testing and Material (ASTM) International, DOI: 10.1520/D4587-11, www.astm.org.]. The test for defects performed for both weathering process depend on the type or application of the paint. The tests for defects such as rusting, chalking, checking etc. are all based on comparing the specimen with a visual standard that is provided by ASTM. Specular gloss was measured at Institute of Chemical and Engineering Sciences (ICES).

TABLE 9
Tests after Accelerated/Natural Weathering (ASTM D4857)

| Defects/ | Roof | Exterior | Metal | Wood | ASTM |
|---|---|---|---|---|---|
| Property | Coating | Paint | Coating | Gloss | Standard |
| Specular gloss | ✓ | ✓ | ✓ | ✓ | D523 |
| Rusting | | | ✓ | | D610 |
| Chalking | | ✓ | | | D4214 |
| Checking | ✓ | ✓ | ✓ | ✓ | D660 |
| Erosion | | ✓ | | | D662 |
| Blistering | ✓ | ✓ | ✓ | | D714 |

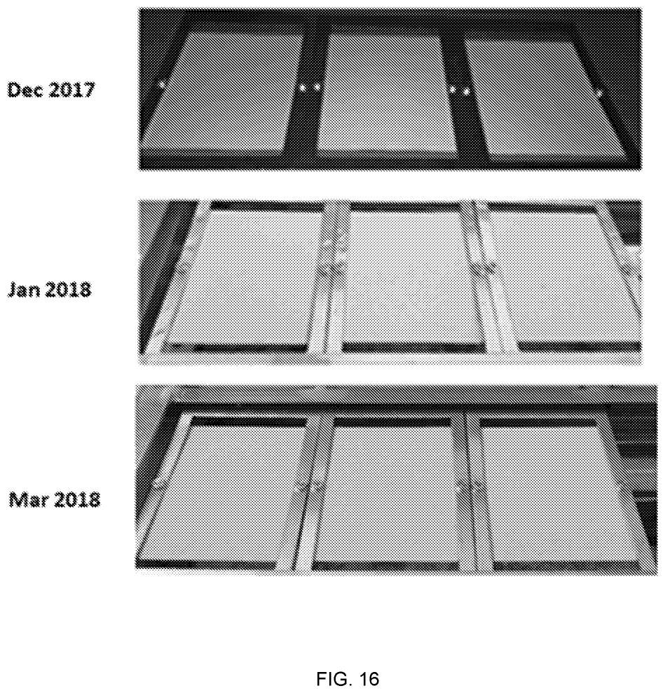

FIG. 16 shows photographs obtained from the weathering tests performed on formulations designed in accordance with various embodiments disclosed herein. Photographs were taken in December 2017, January 2018 and March 2018.

### Example 4: Latex, Silica Nanoparticles and Formulation

### 4.1. Latex Systems

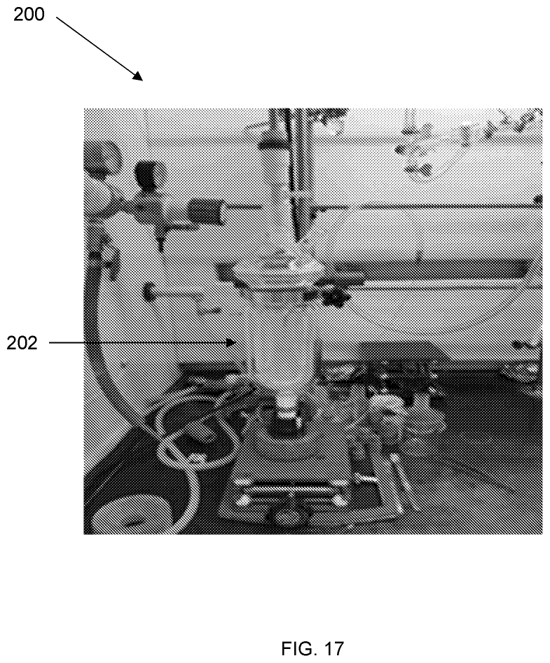

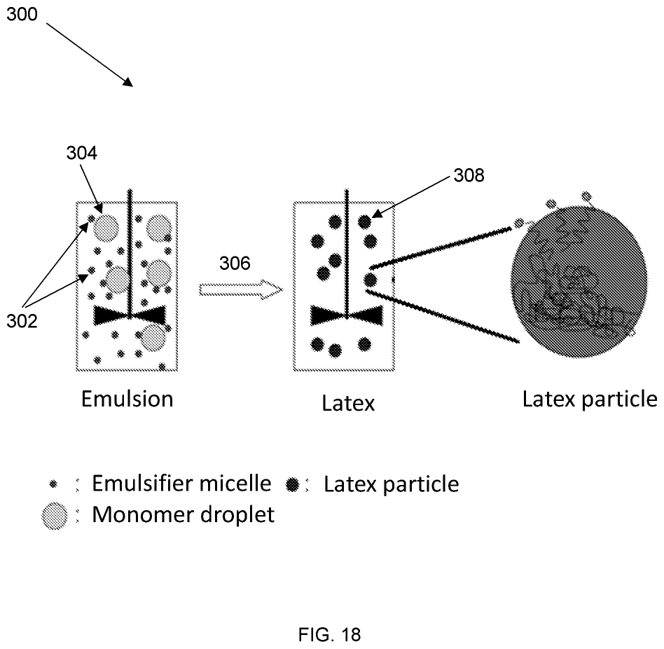

FIG. 17 shows an experimental set up 200 for performing emulsion polymerisation 202 to form latex: starved feeding of monomer to avoid composition drift. FIG. 18 shows a schematic diagram 300 for illustrating emulsion polymerisation. The emulsion is made up of emulsifier micelles 302 and monomer droplets 304. At step 306, as polymerisation continues, emulsifier micelles 302 grow by monomer droplets 304 addition and are converted into latex particles 308.

TABLE 10
Summary of Synthesized Latex Systems

| | | Solid | | | | | | Tg | Mw | | |
|---|---|---|---|---|---|---|---|---|---|---|---|
| Latex | | content | Initiator | Temp | Surfactant | Stir | size | (° C.) | GPC | | |
| Name | Composition | % | % | ° C. | % | rpm | nm | DMA | (THF) | | PDI |
| EM3 | Sty (26%), | 30 | 1 | 70 | 4 | 300 | 42 | 37.1 | 105 | kD | 4.290 |
| | 2EHA (38%), | | | | | | | | | | |
| | MMA (30%), | | | | | | | | | | |
| | MAA (6%) | | | | | | | | | | |
| EM20 | Sty (26%), | 30 | 1 | 70 | 4 | 300 | 41 | 15.0 | 58 | kD | 2.262 |
| | 2EHA (48%), | | | | | | | | | | |
| | MMA (20%), | | | | | | | | | | |
| | MAA (6%) | | | | | | | | | | |
| EM30 | Sty (27.5%), | 50 | 1 | 70 | 1 | 300 | 216 | 2.1 | 377 | kD | 4.792 |
| | 2EHA (49.5%), | | | | | | | | | | |
| | MMA (21.5%), | | | | | | | | | | |
| | MAA (1.5%) | | | | | | | | | | |

Details of 3 other latex systems prepared in accordance with the procedure described above are provided in Table 10. Sodium dodecyl sulfate (SDS) is used as the surfactant and ammonium persulfate is used as the initiator.

### 4.2. Silica Nanoparticles

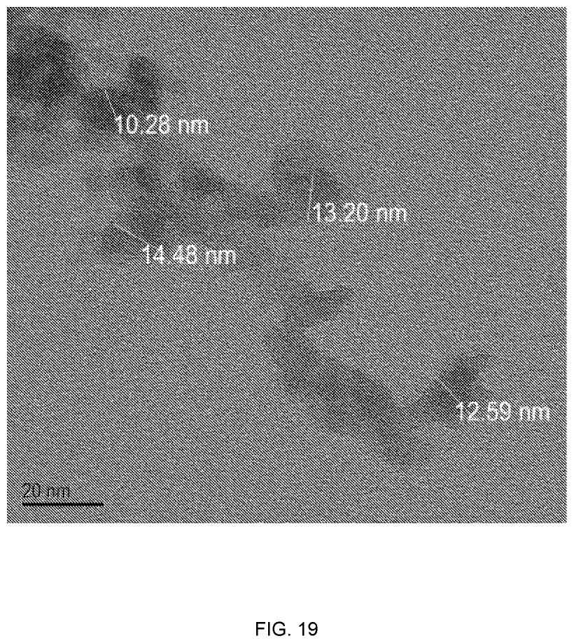

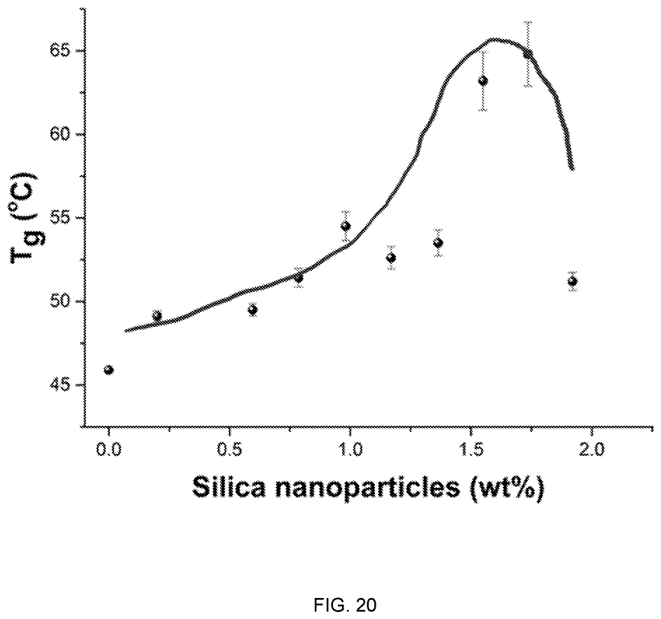

FIG. 19 shows a transmission electron microscopic (TEM) image of silica used in the method designed in accordance with various embodiments disclosed herein. As shown, the particle size of SiO₂ falls within the range of between 10.28 nm and 14.48 nm. FIG. 20 is a graph showing the glass transition temperature (Tg) of exemplary latex designed in accordance with various embodiments disclosed herein and nanocomposites loaded with varying wt % of SiO₂nanoparticles.

### 4.3. SOC and/or Plasticizer Free Paint Formulation

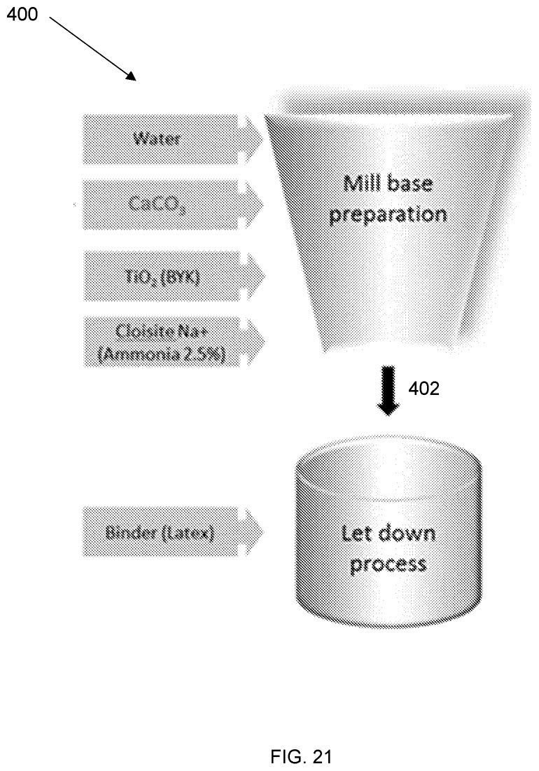

FIG. 21 shows a schematic diagram 400 for illustrating a method of preparing paint formulation in accordance with various embodiments disclosed herein. At step 402, a mill base containing components including water, CaCO₃, TiO₂, cloisite Na⁺ are combined with a latex binder in a let-down process to form paint formulation.

A blank and an ICES plasticizer free paint formulation designed in accordance with various embodiments disclosed herein (hereinafter referred to as “iPF Paint”) were prepared and details of the components present are provided in Table 11. Table 12 lists the glass transition temperature (Tg) of latex, blank and iPF Paint, as measured with dynamic mechanical analysis (DMA).

TABLE 11
Paint Formulation using Latex EM30

| | | |
|---|---|---|
| Components | Blank (g) | iPF Paint* (g) |

Mill base

| | | | |
|---|---|---|---|
| 1 | Water | 32.5 | 32.5 |
| 2 | Defoamer (BYK014) | 0.25 | 0.25 |
| 3 | Ammonia | 1 drop | 1 drop |
| 4 | Dispersant (BYK154) | 1 | 1 |
| 5 | TiO₂ (Tronox) | 55 | 55 |
| 6 | CaCO₃ | 37.5 | 37.5 |
| 7 | Thickener (clay) | 0.375 | 0.375 |
| 8 | Silica (additives) | — | 0.825 |

Let Down

| | | | |
|---|---|---|---|
| 9 | Latex EM30 | 82.5 | 82.5 |

*iPF Paint = ICES Plasticizer free paint

TABLE 12
Tg of Latex Systems, Blank and iPF Paints
Tg ° C. (From DMA)

| | Latex | Blank | iPF Paint |
|---|---|---|---|
| Latex EM30 | 2.1 | 8 | 20 |
| Latex EM31 | 20.5 | 25 | 32 |

*iPF Paint = ICES Plasticizer free paint

Latex EM30=styrene (27.5%), 2-ethyl hexyl acrylate (49.5%), MMA (21.5%) and MAA (1.5%)

Latex EM31=EM31=(27.5%), 2-ethyl hexyl acrylate (44.5%), MMA (26.5%), MAA (1.5%).

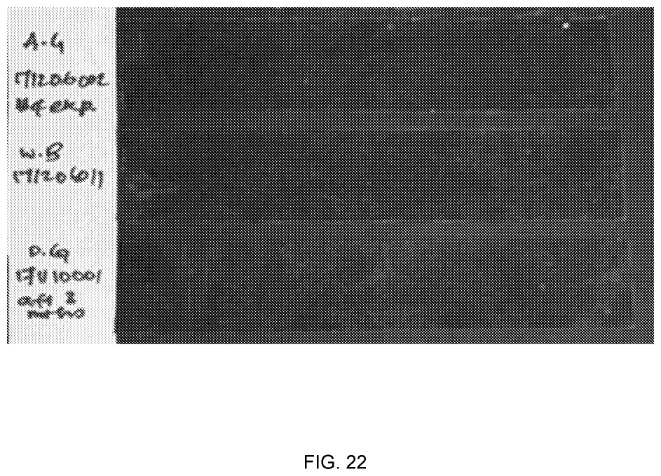

Preliminary observations (FIG. 22):
No cracks in the film
No water marks
No chalking

### 4.4. Performance Evaluation

### 4.4.1. Wet Scrub Resistance (Cycles)

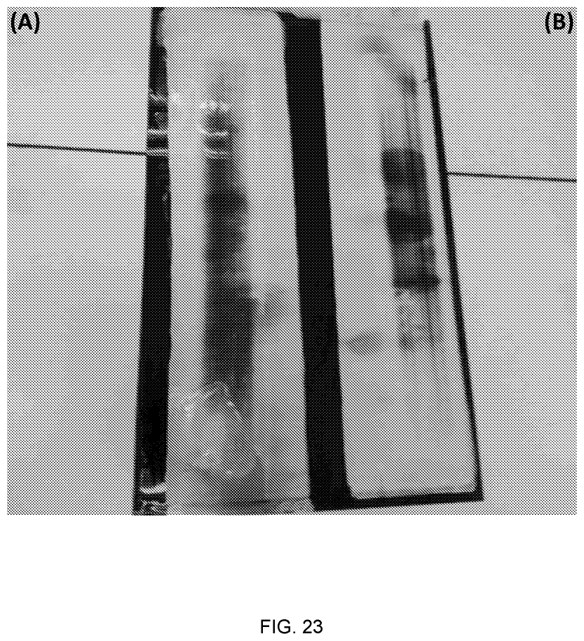

Wet abrasion scrub resistance tests were performed on the blank and iPF Paint. Results are provided in FIG. 23 and Table 13.

TABLE 13
Results of Wet Scrub Resistance (Cycles)
Wet Scrub Resistance (Cycles)

| Blank | iPF Paint |
|---|---|
| 90 | 193 |

### 4.4.2. Permeability (D1653)

Permeability tests were performed on iPF Paint and compared with commercial paints namely, Nippon Weatherbond and Nippon Aqua Bodelac. Results are provided in Table 14.

TABLE 14
Wet Cup and Dry Cup Permeability Calculations

| | | | | |
|---|---|---|---|---|
| | | Rate of flow | Permeance (WVP) | |
| | Surface | of water | grams per m² per 24 h | |
| Paint/ | area, A | vapour, G | millimetre of mercury | Thickness |
| Parameter | (m²) | (g/h) | (metric perms) | (μm) |

Experimental results of wet cup permeability test

| | | | | |
|---|---|---|---|---|
| Nippon | 0.0025 | 0.0259 | 0.0050 | 35.9 |
| Weatherbond | | | (vapor impermeable) | |
| Nippon | 0.001 | 0.004 | 0.0019 | 123.4 |
| Aqua | | | (vapor impermeable) | |
| Bodelac | | | | |
| iPF Paint | 0.0025 | 0.0699 | 0.0358 | 14.7 |
| | | | (vapor impermeable) | |

Experimental results of dry cup permeability test

| | | | | |
|---|---|---|---|---|
| Nippon | 0.0025 | 0.0042 | 0.0020 | 144 |
| Weatherbond | | | (vapor impermeable) | |
| Nippon | 0.001 | 0.0029 | 0.0034 | 144 |
| Aqua | | | (vapor impermeable) | |
| Bodelac | | | | |
| iPF Paint | 0.0025 | 0.00057 | 0.000218 | 13.1 |
| | | | (vapor impermeable) | |

[symbol]

Four Classifications of Vapor Permeance*

| Classification | Permeance |
|---|---|
| Vapor impermeable | 0.1 perm or less |
| Vapor semi- | 1.0 perm or less and |
| impermeable | greater than 0.1 perm |
| Vapor semi- | 10 perms or less and |
| permeable | greater than 1.0 perm |
| Vapor permeable | Greater than 10 perms |

*Source: Lstiburek, Joseph. 850-106: Understanding Vapor Barriers.
Building Science Corporation. Apr. 15, 2011.

### 4.4.3. Q-Lab's Accelerated Weathering Tester (QUV) Exposure Test—ASTM D4587

QUV exposure testing involves a 1^{st} step under UV light and a 2^{nd} step in the dark. The conditions used in each step are detailed in Table 15.

TABLE 15
Steps and Conditions in QUV Exposure Testing

| 1^{st} step: UV | 2^{nd} step: Dark |
|---|---|
| To simulate sunlight- | To simulate |
| using UVA lamps | condensation |
| Duration: 4 h | Duration: 4 h |
| Irradiance: 0.89 W/m2 | Irradiance: NA |
| Temp: 60° C. | Temp: 50° C. |

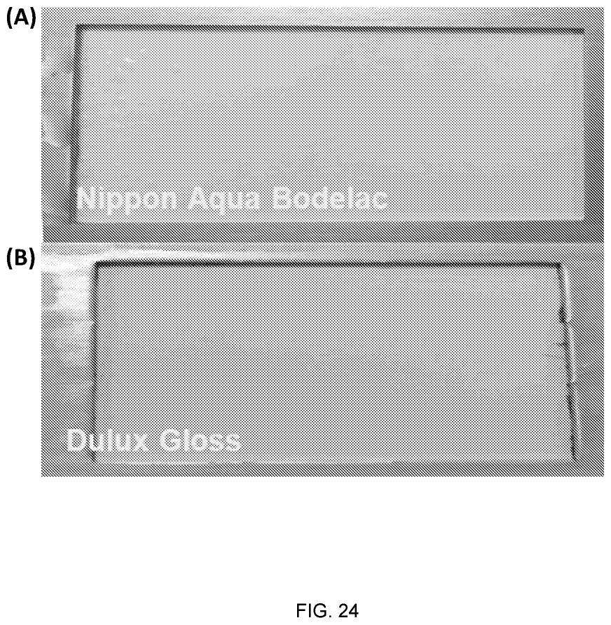

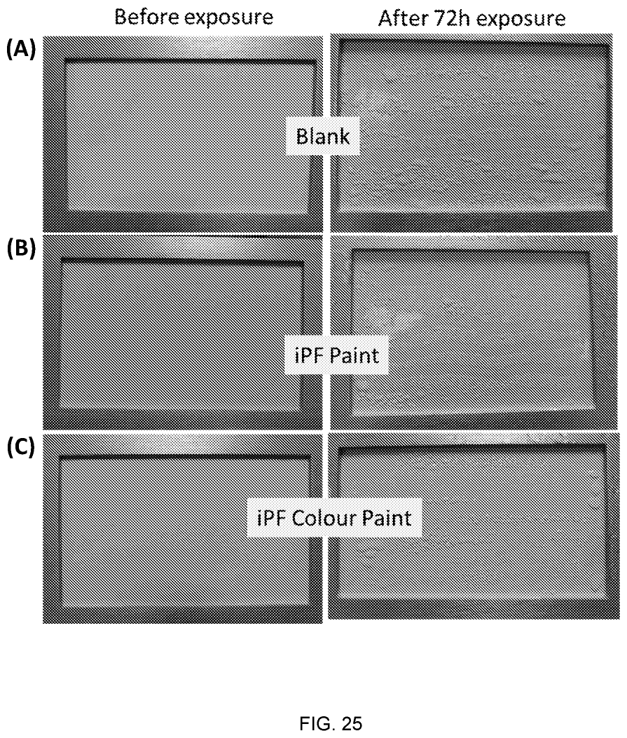

FIG. 24 shows photographs of Nippon Aqua Bodelac and Dulux Gloss paint films after 72 hours of exposure. As shown, there was no physical changes after 72 hours. FIG. 25 shows photographs of paint films before and after 72 hours of QUV exposure test. FIG. 25A shows blank. FIG. 25B shows iPF Paint and FIG. 25C shows iPF Colour Paint.

### 4.4.5. Natural Exposure/Weathering Test

The formulations were tested in Nanyang Technological University (NTU) under natural outdoor weathering for 3 months.

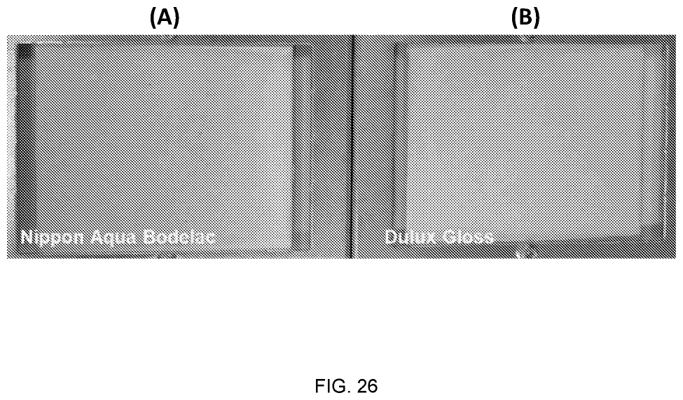

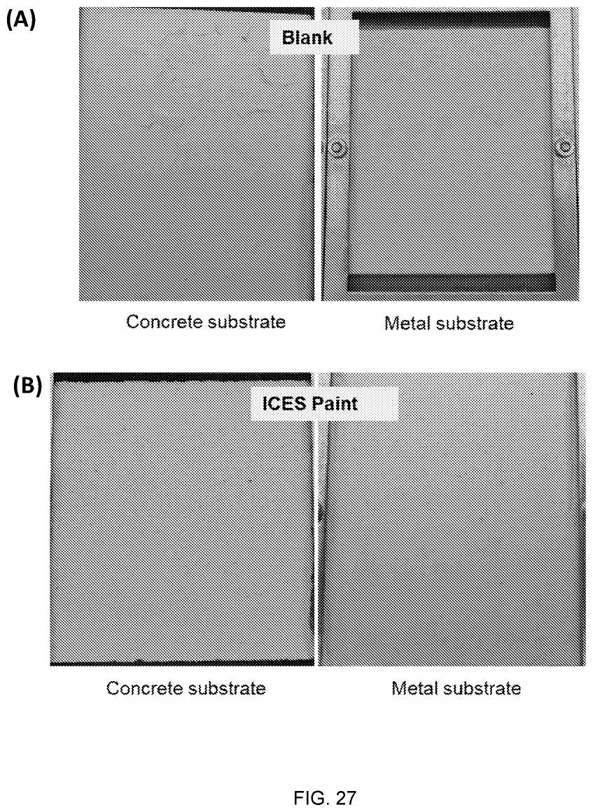

FIG. 26 shows photographs of Nippon Aqua Bodelac and Dulux Gloss paint films after 3 months of natural exposure/weathering. FIG. 27 shows photographs of paint films on concrete and metal substrates after 3 months of natural exposure/weathering. FIG. 27A shows blank. FIG. 27B shows iPF Paint. As shown, the blank paint failed but iPF Paint was still as it was after 3 months of outdoor weathering test.

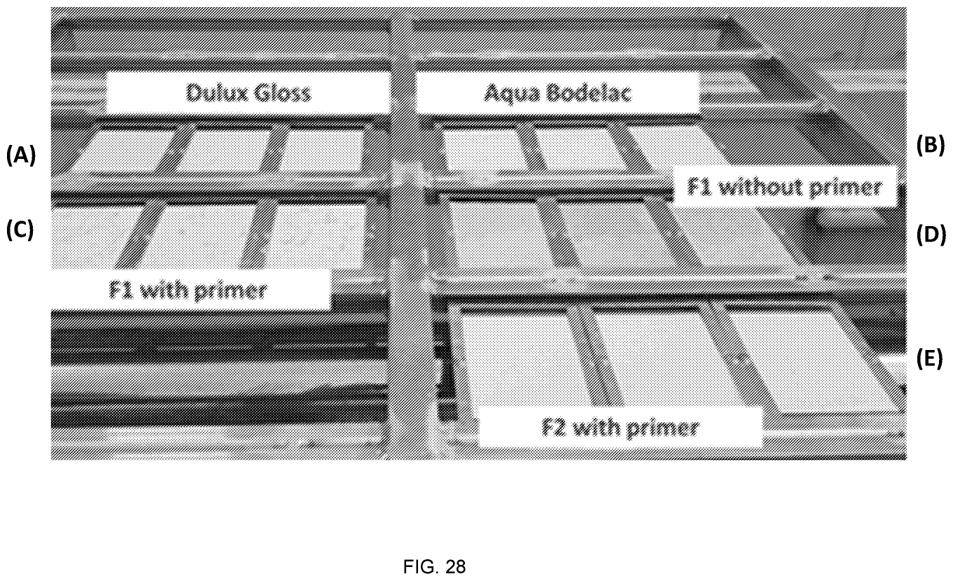

FIG. 28 shows photographs obtained from the weathering tests performed on commercial formulations and formulations designed in accordance with various embodiments disclosed herein. FIG. 28A shows Dulux Gloss. FIG. 28B shows Aqua Bodelac. FIG. 28C and FIG. 28D shows F1 with and without primer respectively. FIG. 28E shows F2 with primer.

### CONCLUSION

The inventors have surprisingly found out that the concept of nanoconfinement effect may be applied to create water-based formulation that may be scaled up for industrial applications. Advantageously, by relying on this concept of a nanoconfinement effect to cause a Tg jump, aqueous polymer (e.g. latex) may be tuned with inorganic particles in the final complex formulation to achieve good film forming property and eventually allows a good quality film to be formed.

It should be appreciated that the concept of using Tg jump caused by interactions between the waterborne polymers (e.g. latex) with designed chain structures and the nanoadditives, to bring about plasticizer-free formulations is a unique, one of its kind approach.

Such an approach in making plasticizer-free formulations is indeed surprising and cannot be easily expected. This is because, in the current paint industry, VOCs or SOCs (i.e. the harmful additives) are deliberately used (usually under the names of film forming agent, plasticizer, coalescing agent etc) as the general conventional wisdom is that they are essential and indispensable.

For example, in known coating formulations such as acrylate based latex paints, SOCs or VOCs are essential components of the formulations. This is because in currently known methods, proper film formation still requires the aid of such small molecules that can intercalate between the polymer chain in order to lower the latex glass transition temperature (Tg). The reduced Tg will then aid the film formation. Upon VOC/SOC/solvent evaporation, there will be a jump on the Tg and the polymer film reverts to its original glass transition temperature in order to produce protective films that are non-tacky with other desirable properties such as mechanical strength. This conventional technology is almost like a modified form of solvent based paint where the plasticizer is working as solvent. Therefore, the use of SOCs or volatile organic compounds (VOCs) in the form of plasticizers remains necessary in current methods used to prepare coating formulations.

Attempting to study the interactions between nano additives in polymer-nanoparticle composites prepared by conventional solvent based approaches with an aim of extrapolating any findings to a water based system is also extremely challenging and far from being straightforward.

In such conventional solvent based approaches, an increase or decrease in Tg depends on the nature of interaction between the inorganic particle and polymer chains; and such interactions in a solvent based approach cannot be easily extrapolated to a water based system, especially given that excessive interaction may take place between nanoparticle and groups in the polymer (e.g. latex) with water molecules through hydrogen bonding.

Indeed, due to the complexity of interactions that take place between nanoparticle and groups in the polymer (e.g. latex) with water molecules in a water-based system, such a system has never been studied in water-based composites. In addition, a water-based paint system of interest adds another level of complexity when a latex particle instead of a soluble particle is used. In this regard, prior to the inventors' findings, it is entirely unclear if the latex particle will undergo inter-diffusion to form a non-tacky film in the presence of interacting polymer and inorganic nanoparticle.

Furthermore, as the paint system usually contains a very large amount of inorganic solids (pigments and fillers), it is doubtful whether a nanoconfinement effect will be effective under such conditions, especially when Tg measurement is not practical in many cases.

Thus, successfully replicating this Tg jump effect by relying on nanoconfinement as a mode of plasticization of the polymer (e.g. latex) without the addition of VOC to create a paint film is a feat that is by no means trivial. Such a finding is even more surprising against the current backdrop of paint industries being inextricably reliant on VOCs for their paint formulations to date.

In summary, it should be appreciated that the presently disclosed concept of using inorganic particles in the composition as a plasticizer replacement is unique and unexpected in several ways and these include but are not limited to:
the use of non-covalent interaction to induce Tg jump to remove plasticizer.
the use of a particular and very small amount (e.g. 1-2 wt %) of inorganic nanoparticle (e.g. silica SiO₂) as a substitute for conventionally used plasticizer in water based polymer (e.g. latex) paint formulation. (It is noted that inorganic nanoparticle is not working as plasticizer, and embodiments of the composition disclosed herein do not require any plasticizer and are thus unique).
the unexpected result of non-covalent interaction of polymer (e.g. latex) with a particular inorganic nanoparticle (e.g. silica SiO₂) that is present as a part of a complex mixture of different nanoparticles having different sizes, functionalities, and densities; and polymer binders having different molecular weights and end chain functionalities.
the unexpected result that just a small amount (e.g. 1-2 wt %) of inorganic nanoparticle (e.g. SiO₂) can function predominantly in a mixture of large amounts (e.g. 40-50 wt %) of other inorganic fillers/pigments in a paint to still achieve the desired effect.
the surprising finding that the non-covalent interaction between inorganic nanoparticle and polymer binder can be directly measured for an unknown material and can be directly correlated with Tg.

In conclusion, the examples show that nanoconfinement effect can be used to create volatile organic compounds (VOC) free coating and/or small organic compound (SOC) free coating in various embodiments of the present disclosure. Accordingly, the examples also show that embodiments of composition/paint composition/coating formulation/film/kit/coated substrate can be substantially devoid of a plant dispersant which may act as a plasticizer. Similarly, embodiments of the composition/paint composition/coating formulation/film/kit/coated substrate disclosed herein can also be substantially devoid of high boiling small molecules that may be creating plasticizing effect (e.g. low volatile plasticizer).

Therefore, embodiments of the composition/paint composition/coating formulation/film/kit/coated substrate disclosed herein advantageously do not pose as an environmental hazard or pollute the environment. Advantageously, in various embodiments, the composition/paint composition/coating formulation/film/kit/coated substrate is environmentally benign/friendly as the composition is a water-based product design which do not contain harmful organic solvents or plasticizers.

Embodiments of the presently disclosed method also provide a commercially viable strategy to produce small organic compounds (SOC) and/or plasticizer free formulations as use of complicated processes was avoided and no significant changes to current running production plants may be required.

Embodiments of the formulations disclosed herein may also be produced at a lower price while showing advantageous properties in terms of various paint characteristics which include good results in scrub resistance stability and accelerated weathering experiments when compared to commercial formulations which contain VOC.

It will be appreciated by a person skilled in the art that other variations and/or modifications may be made to the embodiments disclosed herein without departing from the spirit or scope of the disclosure as broadly described. For example, in the description herein, features of different exemplary embodiments may be mixed, combined, interchanged, incorporated, adopted, modified, included etc. or the like across different exemplary embodiments. The present embodiments are, therefore, to be considered in all respects to be illustrative and not restrictive.

1. A composition comprising:
(i) a polymer;
(ii) inorganic particles; and
(iii) aqueous medium,
wherein the inorganic particles are adapted to interact with the polymer to cause an increase in glass transition temperature (Tg) during film formation of the composition.

2. The composition of claim 1, wherein the increase in Tg during film formation of the composition is due to a nanoconfinement effect.

3. The composition of claim 1, wherein the increase in Tg from Tg of the polymer to Tg of the film comprises a temperature increase in an amount of at least 10° C.

4. The composition of claim 1, wherein the interactions involving the inorganic particles and the polymer in the aqueous medium comprise non-covalent interactions.

5. The composition of claim 1, wherein the composition is substantially devoid of a plasticizer.

6. The composition of claim 1, wherein the composition is substantially devoid of small organic compounds (SOC) and/or volatile organic compounds (VOC).

7. The composition of claim 1, wherein the inorganic particles comprise inorganic nanoparticles having an average size that is no more than 200 nm.

8. The composition of claim 7, wherein the inorganic nanoparticles are selected from the group consisting of silicon dioxide, titanium dioxide, clay, nanocrystalline cellulose and lignin powders.

9. The composition of claim 1, wherein the polymer comprises one or more types of monomers selected from styrene; acrylic acid; methacrylic acid; maleic acid; itaconic acid; acrylonitrile; methacrylonitrile; butadiene; vinylidene chloride; vinyl acetate; and derivatives thereof.

10. The composition of claim 9, wherein the acrylic acid derivative thereof is selected from methyl acrylate, ethyl acrylate, butyl acrylate, 2-ethylhexyl acrylate (2EHA) and N,N,dimethylacrylamide (NNDMA); and the methacrylic acid derivative thereof is selected from methyl methacrylate (MMA) and (hydroxyethyl) methacrylate (HEMA).

11. The composition of claim 1, wherein the aqueous medium is in an amount of from 30 wt % to 60 wt % of the composition.

12. The composition of claim 1, wherein the inorganic particles are in the amount of from 0.05 wt % to 5.0 wt % of the composition.

13. The composition of claim 1, wherein the polymer is in an amount of from 10 wt % to 40 wt % of the composition.

14. The composition of claim 1, wherein the composition is a paint composition and further comprises one or more of the following: pigment, filler, wetting agent, thickening agent, base, anti-foaming agent and dispersing agent.

15-20. (canceled)

21. A coated substrate comprising:
a film disposed on/over a surface of the substrate, the film formed by curing the composition of claim 1 on/over the surface of the substrate,
wherein the inorganic particles are adapted to interact with the polymer in the composition to cause an increase in glass transition temperature (Tg) during film formation.

22. The coated substrate according to claim 21, wherein the film has one or more of the following properties: odourless, non-tacky, non-sticky, excellent resistance to scrub, excellent resistance to abrasion, excellent resistance to washing, low or zero wetting, low water vapour transmission rate under dry conditions, chemically and/or physically stable, excellent resistance towards natural exposure/weathering.

23. The coated substrate according to claim 21, wherein the film has a glass transition temperature in the range of from 15.0° C. to 40.0° C.

24. The method of preparing a coated substrate, the method comprising:
applying the composition of claim 1 on/over a substrate; and
curing the composition to form a film on/over the substrate,
wherein the inorganic particles are adapted to interact with the polymer to cause an increase in glass transition temperature (Tg) during film formation of the composition.

25. The method according to claim 24, wherein prior to the applying step, the method comprises:
mixing inorganic particles, aqueous medium and optionally one or more of pigment, filler, wetting agent, thickening agent, base, anti-foaming agent, and dispersing agent, to form a mill base; and
mixing said mill base with a polymer to form the composition.

26. The method according to claim 25, wherein the step of mixing to form a mill base comprises stirring the mixture until the particle size is less than 50 μm as determined by a Hegman gauge.
